(19) United States
(12) Patent Application Publication
(10) Pub. No.: US 2025/0209413 A1
(43) Pub. Date: Jun. 26, 2025

(54) TRACKING FULFILLMENT OF OBJECTS IN A TRANSACTION

(71) Applicant: Synchrony Bank, Stamford, CT (US)

(72) Inventors: Jeff Silverman, Stamford, CT (US); Alyssa Clement, Stamford, CT (US); Jennifer Chaffin, Stamford, CT (US); Vivek Menon, Stamford, CT (US); William Kievit, Stamford, CT (US)

(21) Appl. No.: 18/975,327

(22) Filed: Dec. 10, 2024

Related U.S. Application Data
(60) Provisional application No. 63/613,257, filed on Dec. 21, 2023.

(51) Int. Cl. G06Q 10/0833; G06Q 10/0631

(52) U.S. Cl. CPC G06Q 10/0833; G06Q 10/063114

(57) ABSTRACT

Disclosed embodiments may provide techniques for tracking fulfillment statuses of objects associated with transactions. A computer-implemented method can include identifying receiving a request for distribution of resources. The resources can be associated with a transaction, and the transaction is associated with a set of objects. The computer-implemented method can also include detecting one or more fulfillment actions associated with the set of objects. The computer-implemented method can also include determining that fulfillment conditions associated with a subset of objects have been satisfied. The satisfaction of the fulfillment conditions can be determined based on the one or more fulfillment actions. The computer-implemented method can also include identifying a fulfillment metric associated with the subset of objects. The computer-implemented method can also include determining that the fulfillment metric exceeds a predetermined threshold. The computer-implemented method can also include distributing the resources after determining that the fulfillment metric exceeds the predetermined threshold.

### CROSS-REFERENCES TO RELATED APPLICATIONS

The present application claims priority from and is a non-provisional of U.S. Provisional Application No. 63/613,257, entitled “TRACKING FULFILLMENT OF OBJECTS IN A TRANSACTION” filed Dec. 23, 2023, the contents of which are herein incorporated by reference in its entirety for all purposes.

### FIELD

The present disclosure relates generally to techniques for tracking fulfillment of transactions. In one example, the systems and methods described herein may be used to track fulfillment statuses of objects associated with transactions.

### SUMMARY

Disclosed embodiments may provide techniques for tracking fulfillment statuses of objects associated with transactions. A computer-implemented method can include identifying receiving a request for distribution of resources. In some instances, the resources are associated with a transaction to be fulfilled by an entity, and the transaction is associated with a set of objects. The computer-implemented method can also include detecting in real-time one or more fulfillment actions associated with the set of objects. In some instances, detecting the one or more fulfillment actions includes analyzing signal data generated by a plurality of sensors. The one or more fulfillment actions can be detected in real-time as a plurality of fulfillment actions associated with other objects are being received.

The computer-implemented method can also include determining in real-time that fulfillment conditions associated with a subset of objects have been satisfied. For example, the fulfillment conditions can include a completion of a shipment associated with a corresponding object of the subset of objects. The satisfaction of the fulfillment conditions can be determined in real-time as the plurality of fulfillment actions associated with the other objects are being received. In some instances, the satisfaction of the fulfillment conditions is determined based on the one or more fulfillment actions. In some instances, determining the satisfaction of the fulfillment conditions includes applying a machine-learning model to the one or more fulfillment actions and domain data associated with the set of objects to generate an output indicating whether the fulfillment conditions have been satisfied. The output of the machine-learning model can then be used to determine that the fulfillment conditions associated with the subset of objects have been satisfied based on the output.

The computer-implemented method can also include identifying a fulfillment metric associated with the subset of objects. For example, the fulfillment metric can include a total pecuniary value corresponding to the subset of objects. In another example, the fulfillment metric can include a count of objects corresponding to the subset of objects. In yet another example, the fulfillment metric can include a time point at which the fulfillment conditions have been satisfied.

The computer-implemented method can also include determining that the fulfillment metric exceeds a predetermined threshold. In some instances, the predetermined threshold includes a statistical value associated with the resources. The predetermined threshold can be determined based on domain data associated with the set of objects. Additionally or alternatively, the predetermined threshold can be determined based on an elapsed time from a time point at which the request for the distribution of resources was received. The computer-implemented method can also include distributing the resources after determining that the fulfillment metric exceeds the predetermined threshold. In some instances, distributing the resources includes generating a notification indicating the distribution of the resources.

In some instances, the computer-implemented method includes determining that the fulfillment metric does not exceed the predetermined threshold. After determining that the fulfillment metric does not exceed the predetermined threshold, additional fulfillment actions associated with the set of objects can be monitored.

Additionally or alternatively, the computer-implemented method can also include determining that the fulfillment metric does not exceed the predetermined threshold. After determining that the fulfillment metric does not exceed the predetermined threshold, an amount of resources to be distributed can be adjusted and distributed.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram for tracking fulfillment statuses of objects associated with transactions, according to some embodiments.

FIG. 2 illustrates an example computing environment for tracking fulfillment statuses of objects associated with transactions, according to some embodiments.

FIG. 3 illustrates an example computing environment that includes a special-purpose computer configured to track fulfillment statuses of objects associated with transactions, according to some embodiments.

FIG. 4 shows an illustrative example of a process for tracking fulfillment statuses of objects associated with transactions, in accordance with some embodiments.

FIG. 5 illustrates an example schematic diagram for tracking fulfillment conditions, according to some embodiments.

FIG. 6 illustrates an example schematic diagram for distributing resources based on fulfillment metrics, according to some embodiments.

FIG. 7 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide techniques for monitoring and tracking fulfillment of transactions. A fulfillment-tracking application can receive a request for distribution of resources. In some instances, the resources are associated with a transaction to be fulfilled by an entity. As an illustrative example, a user purchases a set of objects from a website, in which the objects include a mobile phone, a soccer jersey, and a dishwasher. To complete the transaction, the user enrolls in an installment plan provided by a resource provider. The enrollment of the installment plan can specify that the user has agreed to a recurring transfer of resources to the resource provider over a time period, in exchange for the resource provider immediately providing the resources to the web service provider to complete the transaction. The web service provider can determine that the user has successfully enrolled in the installment plan and subsequently authorize the user to purchase the set of objects. After authorizing the purchase, the web service provider can transmit a request to the resource provider to distribute the resources to complete the purchase the set of objects.

The transaction can be associated with a set of objects. Continuing with the above example, the transaction can be associated with the set of objects that include the mobile phone, the soccer jersey, and the dishwasher. The resource provider can distribute the requested resources once the three objects are shipped to the user. Depending on the domain and/or data-processing rules set by the resource provider, the resources can be distributed even if fulfillment has not been completed for all three objects (e.g., only two items were shipped).

The fulfillment-tracking application can detect in real-time one or more fulfillment actions associated with the set of objects. In some instances, the one or more fulfillment actions are detected in real-time as a plurality of fulfillment actions associated with other objects are being received. The one or more fulfillment actions can include any actions performed by the entity (e.g., the web service provider) to complete and fulfill the transaction for the user. Continuing with the above example, the fulfillment-tracking application can detect that the mobile phone and the soccer jersey were shipped to the user's address. The fulfillment-tracking application can further detect that an order was submitted to transfer the dishwasher to a warehouse associated with the web service provider. The fulfillment-tracking application can detect the above actions in real-time, even as a large number of actions (e.g., more than 1000 actions) were or are being performed by the web service provider. In some instances, the one or more fulfillment actions include actions performed by the user or another third party that are associated with completion of the transaction. Continuing with the example, the fulfillment-tracking application can detect a successful delivery performed by a third-party shipping provider to the user's address.

The fulfillment-tracking application can determine in real-time that fulfillment conditions associated with a subset of objects have been satisfied. The satisfaction of the fulfillment conditions can be determined based on the one or more fulfillment actions. Continuing with the example, the fulfillment-tracking application can determine that completed shipments of the mobile phone and the soccer jersey satisfies their respective fulfillment conditions. By contrast, the fulfillment-tracking application can determine that the delivery of the dishwasher to the warehouse does not satisfy a corresponding fulfillment condition associated with the purchase of the dishwasher. The non-static, real-time determination of fulfillment conditions can result in a rapid distribution of resources that are substantially more efficient than other conventional techniques that rely on passive collection of data over a given period of time.

The fulfillment-tracking application can identify a fulfillment metric associated with the subset of objects. In some instances, the fulfillment metric includes a total pecuniary value (e.g., a total dollar amount) corresponding to the subset of objects. Additionally or alternatively, the fulfillment metric can include a count of objects corresponding to the subset of objects (e.g., 4 objects). Continuing with the example, the fulfillment metric associated with the shipped mobile phone and the soccer jersey can be 0.667, which corresponds to a percentage of the count of shipped objects relative to the total number of objects associated with the transaction.

The fulfillment-tracking application determines that the fulfillment metric exceeds a predetermined threshold. The fulfillment-tracking application can determine the predetermined threshold based on a type of fulfillment metric that represents the subset of objects. For example, if the fulfillment metric corresponds to a total pecuniary value of the subset of objects (e.g., 550 USD), the predetermined threshold can be a percentage of the total pecuniary value of the set of objects (e.g., 75% of 600 USD). Continuing with the example, the fulfillment-tracking application can determine that the fulfillment metric of 0.667 exceeds the predetermined threshold of 0.5.

In some instances, the predetermined threshold is determined based on domain data associated with the set of objects. The predetermined thresholds are different across various domains, because a particular value that is relevant for assessing fulfillment conditions for a particular domain can be less relevant for other domains. As an illustrative example relating to fulfillment metrics corresponding to the elapsed time, a predetermined threshold relating to transactions involving furniture can be 6 months, whereas another predetermined threshold relating to transactions involving electronic devices can be 90 days.

The fulfillment-tracking application distributes the resources after determining that the fulfillment metric exceeds the predetermined threshold. Continuing with example, if the fulfillment-tracking application determines that the fulfillment metric of 0.667 exceeds the predetermined threshold, the fulfillment-tracking application can proceed with distributing the resources associated with the transaction. In some instances, the fulfillment-tracking application can generate a notification indicating the distribution of the resources.

In some instances, if the fulfillment-tracking application determines that the fulfillment metric does not exceed the predetermined threshold, the fulfillment-tracking application adjusts an amount of resources to be distributed after determining that the fulfillment metric does not exceed the predetermined threshold. The fulfillment-tracking application can then distribute the resources using the adjusted amount of resources.

Additionally or alternatively, if the fulfillment-tracking application determines that the fulfillment metric does not exceed the predetermined threshold, the fulfillment-tracking application can repeat the data collection steps and monitor for additional fulfillment actions associated with the set of objects after determining that the fulfillment metric does not exceed the predetermined threshold.

### I. TRACKING FULFILLMENT STATUSES OF OBJECTS ASSOCIATED WITH TRANSACTIONS

### A. Example Implementation

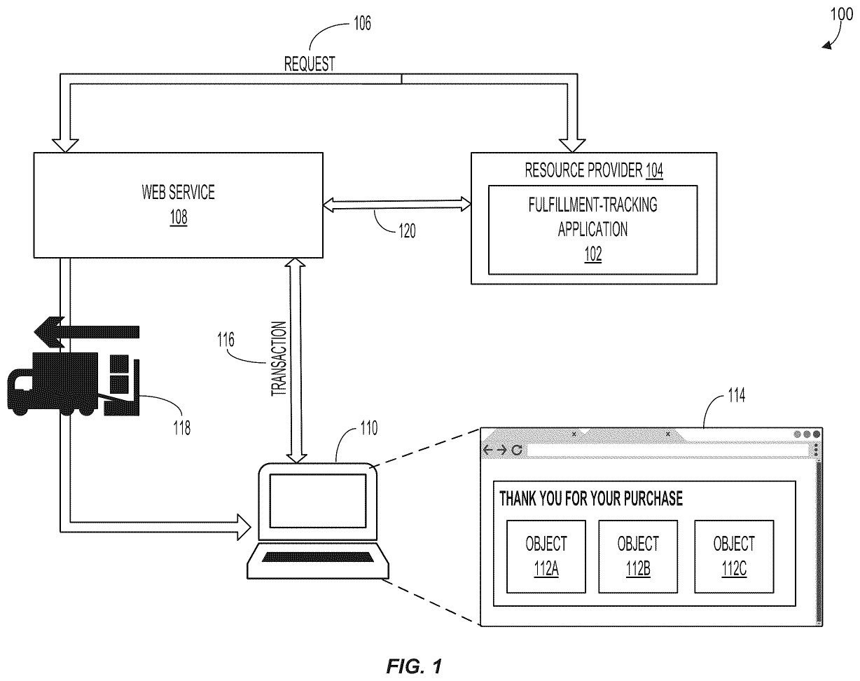

FIG. 1 illustrates an example schematic diagram 100 for tracking fulfillment statuses of objects associated with transactions, according to some embodiments. As shown in FIG. 1, a fulfillment-tracking application 102 of a resource provider 104 can receive a request 106 for distribution of resources from a web service 108. The resources can include any tangible or intangible assets that can be exchanged for performance of a transaction. In some instances, the resources are associated with a transaction to be fulfilled by the web service 108. The transaction can include any interaction with the web service 108 in which a user device 110 transfers the resources with the web service 108 to obtain goods or services. The resource provider 104 thus provides the resources to the web service 108, after the web service 108 successfully fulfills the transaction on behalf of a user of the user device 110. As an illustrative example, the web service 108 can initiate the fulfillment of the transaction by authorizing the transaction associated with a user after determining that an installment plan has been registered between the user and the resource provider 104. To receive the resources, the web service 108 can generate the request for distribution of the resources after the transaction has been authorized for the user. In response, the resource provider 104 can track whether the web service 108 fulfilled the transaction.

The transaction can be associated with a set of objects 112A-C to be obtained by the user of the user device 110. The objects can include physical objects, intangible objects such as pecuniary values or intellectual property, and/or services. As shown in FIG. 1, a browser 114 of the user device 110 can display the set of objects 112A-C associated with a transaction 116. For example, the transaction 116 can include a purchase of three objects 112A-C, in which the resources are distributed by the resource provider once the web service 108 completes fulfillment (e.g., shipping) of the three objects 112A-C. The three objects 112A-C are shown for illustrative purposes only, and the transaction 116 can include a purchase of any number of objects. For example, the set of objects for a single transaction can include at least 2, 3, 4, 5, 10, 15, 20, or more than 20 objects. In some instances, the set of objects correspond to the same object in multiple quantities. With reference to FIG. 1, the object 112A can be the same type of object as the object 112B. In some instances, an object of the set is different from at least another object in the set. For example, an object of the set can be an intangible object (e.g., virtual gift card), whereas another object can be a physical object (e.g., a clothing item).

After the request 106 is received, the fulfillment-tracking application 102 detects in real-time one or more fulfillment actions 118 associated with the set of objects 112. The one or more fulfillment actions can include any actions performed by the entity to complete and fulfill the transaction for the user. With reference to FIG. 1, the one or more fulfilment actions 118 can include any action performed by the web service 108 and/or other third-party service providers to facilitate the user device 110 to obtain the set of objects 112A-C. In some instances, the one or more fulfillment actions correspond to at least one object of the set of objects. For example, the fulfillment actions can include the web service 108 shipping the object 112A to a user's address. In some instances, the one or more fulfillment actions can include actions performed by the user or another third party that are associated with completion of the transaction. For example, the fulfillment actions 118 can include the user activating the virtual gift card corresponding to the object 118C, or a third party acknowledging delivery of the corresponding object to the user's mailing address.

In some instances, a fulfillment action of the one or more fulfillment actions 118 can include actions that are specific to a particular object (e.g., the object 112C). In some instances, the fulfillment actions for the particular object (e.g., the object 112C) are different from fulfillment actions of other objects (e.g., the objects 112A-B). For example, the fulfillment-tracking application can detect that a virtual gift card has been activated for the object 112C, while monitoring shipments for the objects 112A-B. As a result, the fulfillment-tracking application can monitor for various types of fulfillment actions that are specifically being performed for the set of objects 112A-C.

In some instances, the fulfillment actions for a particular object can be associated with a time frame that can be different from similar fulfillment actions of other objects. For example, a shipment of an electronic device can be performed within two business days, but a shipment of a furniture can take more than two months. To accommodate for these differences, the fulfillment-tracking application can use various conditions and thresholds to assess whether a given action successfully fulfills the transaction.

The one or more fulfillment actions 118 can be detected in real-time as a plurality of fulfillment actions associated with other objects are being received. In effect, the non-static, real-time detection of the one or more fulfillment actions 118 can result in an output at a particular time point being different from other outputs generated based on other fulfillment actions detected in different time points (e.g., 10 seconds later, 30 seconds later, 1 minute later, 5 minutes later, 10 minutes later). In some instances, the one or more fulfillment actions 118 can be detected by the fulfillment-tracking application 102 analyzing signal data generated by a plurality of sensors.

After the one or more fulfillment actions 118 are detected, the fulfillment-tracking application 102 determines in real-time that fulfillment conditions associated with a subset of objects have been satisfied. The satisfaction of the fulfillment conditions can be determined based on the one or more fulfillment actions. With reference to FIG. 1, the fulfillment-tracking application 102 can determine that a first fulfillment condition for the object 112A has been satisfied based on successful shipment of the object 112A to the address of the user. In another example, the fulfillment-tracking application 102 can determine that a third fulfillment condition of the object 112C has been satisfied based on an activation of the corresponding virtual gift card. The fulfillment-tracking application 102 can additionally determine that a second fulfillment condition for the object 112B has not been satisfied, as the web service 108 continues to prepare shipment of the object 112B to the address of the user. In some instances, the satisfaction of the fulfillment conditions is determined in real-time as the plurality of fulfillment actions associated with the other objects are being received. The non-static, real-time determination of fulfillment conditions can result in a rapid distribution of resources that are substantially more efficient than other conventional techniques that rely on passive collection of data over a given period of time.

To identify the subset of objects, the fulfillment-tracking application 102 can preprocess the one or more fulfillment actions in a structured data format, in which the structured data can include each of the one or more fulfillment actions being associated with a corresponding identifier, a type of fulfillment action, and objects (e.g., the object 112A) of the transaction to which the fulfillment action is related. The fulfillment-tracking application 102 can apply one or more data-processing rules to the structured data to identify the subset of objects that satisfy the fulfillment conditions. The fulfillment-tracking application 102 can access the data-processing rules from a condition database, in which each of the data-processing rules is generated to determine whether fulfillment actions satisfy a corresponding condition.

In some instances, to determine the satisfaction of the fulfillment conditions, the fulfillment-tracking application 102 applies a machine-learning model to the one or more fulfillment actions and domain data associated with the set of objects to generate an output indicating whether the fulfillment conditions have been satisfied. The fulfillment-tracking application 102 can determine that the fulfillment conditions associated with the subset of objects have been satisfied based on the output. The machine-learning model may be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. As may be contemplated, the terms “machine learning” and “artificial intelligence” are frequently used interchangeably due to the degree of overlap between these fields and many of the disclosed techniques and algorithms have similar approaches.

In some instances, the fulfillment-tracking application 102 identifies a fulfillment metric associated with the subset of objects. The fulfillment metric can include any type of value that represent one or more characteristics associated with the subset of objects. In some instances, the fulfillment metric includes a statistical value associated with the subject of objects. For example, the fulfillment metric includes a total pecuniary value (e.g., a total dollar amount) corresponding to the subset of objects. In another example, the fulfillment metric can include a count of objects corresponding to the subset of objects (e.g., 4 objects). Additionally or alternatively, the fulfillment metric can include a time-based metric associated with the subject of objects. For example, the fulfillment metric can include a time point at which the fulfillment conditions for the subset of objects have been satisfied. With reference to FIG. 1, the fulfillment metric corresponding to the objects 112A and 112C can be “2”, which corresponds to a total count of objects of the subset. In another example, the fulfillment metric corresponding to the objects 112A and 112C can be 400.00 USD, which corresponds to the total pecuniary value corresponding to the objects 112A and 112C.

The fulfillment-tracking application 102 determines that the fulfillment metric exceeds a predetermined threshold. The predetermined threshold can be determined based on a type of the fulfillment metric representing the subset of objects. With reference to FIG. 1, if the fulfillment metric of the objects 112A and 112C corresponds to 400 USD, the predetermined threshold can be a percentage of the total pecuniary value of the set of objects (e.g., 30% of 1000 USD). In another example, if the fulfillment metric of the objects 112A and 112C corresponds to the count of objects (i.e., 2), the predetermined threshold can correspond to a predetermined percentage of the count of objects (e.g., 50% of the total count of the set of objects 112A-112C).

In some instances, the predetermined threshold is determined based on domain data associated with the set of objects. In some instances, the predetermined threshold relating to the elapsed time corresponds to a first value for a first domain, a second value for a second domain, a third value for a third domain, and so on. The predetermined thresholds are different across various domains, because a particular value that is relevant for assessing fulfillment conditions for a particular domain can be less relevant for other domains. As an illustrative example relating to fulfillment metric corresponding to the elapsed time, a predetermined threshold relating to transactions involving furniture can be 6 months, whereas another predetermined threshold relating to transactions involving electronic devices can be 90 days. In another example relating to fulfillment metrics corresponding to account of the subset of objects, a predetermined threshold relating to transactions involving furniture can be 80% of the total count of objects (since there is a likelihood of a shipment delay), whereas another predetermined threshold relating to transactions involving electronic devices can be 100%.

Additionally or alternatively, the predetermined threshold can be determined based on the domain data from two or more domains. In particular, the fulfillment-tracking application 102 can determine the predetermined threshold based on the domain associated with an object having the highest pecuniary value. For example, if the transaction includes a purchase of a shirt and a mattress, the fulfillment-tracking application 102 can determine the predetermined threshold based on domain data associated with the furniture items. In some instances, the fulfillment-tracking application 102 determines the predetermined threshold based on the domain of an object having a shorter fulfillment period. For example, if the transaction includes a purchase of a gaming laptop and a mattress, the fulfillment-tracking application 102 can determine the predetermined threshold based on domain data associated with the electronic device, as the mattress takes the longer time for shipment (e.g., 3 months) relative to the gaming laptop (e.g., 2 days).

The fulfillment-tracking application 102 distributes the resources after determining that the fulfillment metric exceeds the predetermined threshold. With reference to FIG. 1, the fulfillment-tracking application 102 can proceed with distributing the resources associated with the transaction in response to determining that the fulfillment metric (e.g., 400 USD) exceeds the predetermined threshold (e.g., 30% of 1000 USD). In some instances, the fulfillment-tracking application 102 can generate a notification indicating the distribution of the resources. The fulfillment-tracking application 102 can then transmit the notification to the web service 108 and/or the user device 110.

In some instances, if the fulfillment-tracking application 102 determines that the fulfillment metric does not exceed the predetermined threshold, the fulfillment-tracking application 102 adjusts an amount of resources to be distributed after determining that the fulfillment metric does not exceed the predetermined threshold. The fulfillment-tracking application can then distribute the resources using the adjusted amount of resources. For example, if the transaction involves 5 objects and only a single object has been shipped to the user, the fulfillment-tracking application 102 can determine that fulfillment metric corresponding to a single object does not exceed the predetermined threshold (e.g., 3 objects). Continuing with the example, the fulfillment-tracking application 102 can adjust the amount of resources corresponding to the single object that has been shipped to the user rather than distributing the full amount of resources requested by the web service 108. In this manner, the fulfillment-tracking application 102 can transfer portions of the requested resources even when the fulfillment of the set of objects are incomplete.

Additionally or alternatively, if the fulfillment-tracking application 102 determines that the fulfillment metric does not exceed the predetermined threshold, the fulfillment-tracking application 102 can repeat the data collection steps and monitor for additional fulfillment actions associated with the set of objects after determining that the fulfillment metric does not exceed the predetermined threshold. With reference to FIG. 1, if the shipment of the objects 112A and 112C does not satisfy the corresponding fulfillment conditions and/or the corresponding fulfillment metric does not exceed the predetermined threshold, the fulfillment-tracking application 102 can return to monitoring for additional fulfillment actions to be performed for the set of objects.

### B. System Components for Tracking Fulfillment Statuses of Objects Associated With Transactions

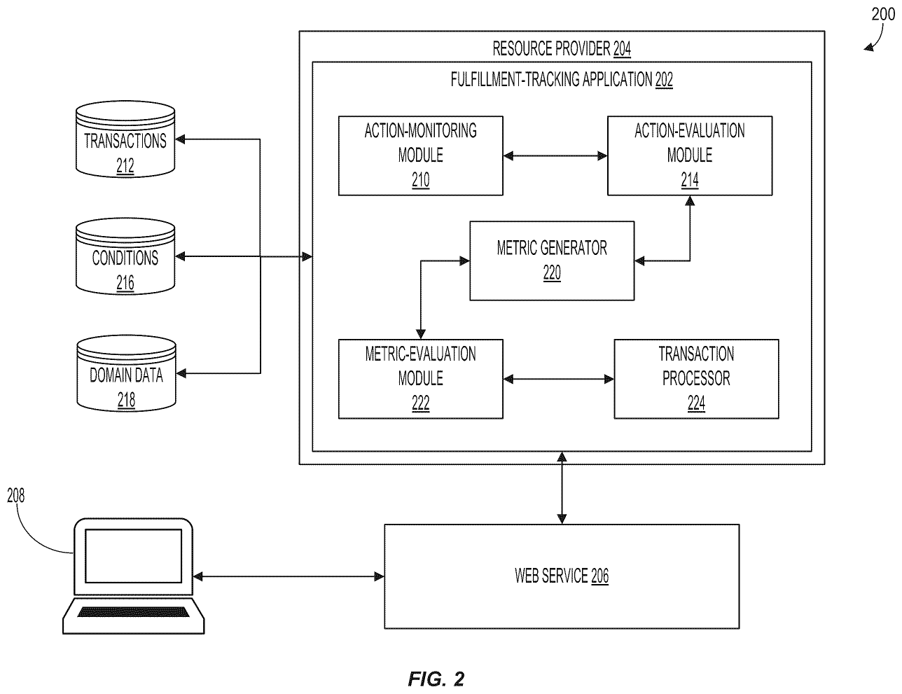

FIG. 2 illustrates an example computing environment 200 for tracking fulfillment statuses of objects associated with transactions, according to some embodiments. In the computing environment 200, a fulfillment-tracking application 202 of a resource provider 204 (e.g., a financial institution) can receive a request for distribution of resources from a web service 206. In some instances, the resources are associated with a transaction to be fulfilled by an entity associated with the web service 206 (e.g., a merchant website) and/or other third-party services, in which the resources can include any tangible or intangible assets that can be exchanged for performance of the transaction. The transaction can include any interaction in which a user of a user device 208 transfers resources with the entity to obtain goods or services. In some embodiments, the resource provider 204 provides the resources to the web service 206, after the web service 206 successfully fulfills the transaction on behalf of the user of the user device 208. For example, the web service 206 can authorize the transaction associated with the user in exchange for the resource provider 204 providing the corresponding resources. To receive the resources, the web service 206 can generate the request after the transaction has been authorized for the user of the user device 208, at which the resource provider 204 can track whether the web service 206 has fulfilled the transaction. In some instances, the request includes a request for distributing the resources across multiple service providers that participated in the transaction. For example, the web service 206 and a delivery service provider can be both identified in the request, such that a first portion of the resources is distributed to the web service 206 while a second portion of the resources is distributed to the delivery service provider. The above example is for illustration purposes only, and the number of service providers identified in the request can include 1, 2, 3, 4, 5, 10, 15, 20, or more than 20 service providers.

The fulfillment-tracking application 202 can receive and communicate with the web service 206 across a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

In some instances, the fulfillment-tracking application 202 communicates with the web service 206 by using application programming interfaces (APIs). For example, the request can be transmitted by the web service 206 using an API protocol such as Hypertext Markup Language (HTML), Extensible Markup Language (XML), JavaScript®, Cascading Style Sheets (CSS), JavaScript® Object Notation (JSON), and other such protocols and/or structured languages. The API request transmitted by the web service 206 can include an identifier associated with the transaction, account data associated with the user, additional details associated with the transaction (e.g., purchased objects, a total amount of transaction, merchant identifier associated with the web service 206, identifiers associated with third-party service providers that participated in the transaction), an amount requested for distribution, and one or more actions performed by the web service 206 to fulfill the transaction. The fulfillment-tracking application 202 can parse the API request to generate an API response, which can include the requested resources, an adjusted amount from the requested resources, or a message indicating that the resources cannot be distributed until successful fulfillment of the corresponding transaction.

The transaction can be associated with a set of objects. The objects can be physical objects, intangible objects such as pecuniary values or intellectual property, and/or services. For example, an object can be a tangible object such as an electronic device, and another object can be an intangible object such as a video file, downloadable video game, or a music file. The fulfillment-tracking application 202 can identify each of the set of objects by concatenating the transaction identifier with a corresponding object identifier for the object. As an illustrative example associated with the transaction, the transaction can include a purchase of five objects, in which the resources are distributed by the resource provider 204 once the entity completes fulfillment (e.g., shipping) of the five objects. Depending on the domain and/or data-processing rules set by the resource provider, the resources can be distributed even if all five objects have not yet been fulfilled (e.g., only three items were shipped) by the web service 206. In some embodiments, the set of objects for a single transaction includes at least 2, 3, 4, 5, 10, 15, 20, or more than 20 objects. The set of objects can correspond to the same object in multiple quantities. In some instances, an object of the set is different from at least another object in the set. For example, an object of the set can be an intangible object (e.g., virtual gift card), whereas another object can be a tangible object (e.g., a clothing item).

The fulfillment-tracking application 202 can be implemented by a computer system, which can take any suitable physical form. As example and not by way of limitation, the computer system of the resource provider 204 can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider (e.g., the computing resources provider 728).

The fulfillment-tracking application 202 can include various modules or components to track fulfillments in various transactions. With reference to FIG. 2, the fulfillment-tracking application 202 can include an action-monitoring module 210 that detects in real-time one or more fulfillment actions associated with the set of objects. The action-monitoring module 210 can detect one or more fulfillment actions in real-time as a plurality of fulfillment actions associated with other objects are being received. For example, the action-monitoring module 210 can parse data transmitted by the web service 206 and/or other service providers in real-time to identify the plurality of fulfillment actions, identify in real-time the one or more fulfillment actions from the plurality of fulfillment actions, and associate in real-time the one or more fulfillment actions with objects associated with the transaction of the request. Additionally or alternatively, the action-monitoring module 210 can perform the above operations in real-time by associating each fulfillment action of the plurality of fulfillment actions with a corresponding transaction identifier stored in a transactions database 212. In effect, the non-static, real-time detection of the one or more fulfillment actions can result in an output at a particular time point being different from other outputs generated based on other fulfillment actions detected in different time points (e.g., 10 seconds later, 30 seconds later, 1 minute later, 5 minutes later, 10 minutes later).

The one or more fulfillment actions can include any actions performed by the web service 206 to complete and fulfill the transaction for the user of the user device 208. In some instances, the one or more fulfillment actions correspond to at least one object of the set of objects. For example, the fulfillment actions can include retrieving a corresponding object from a product warehouse or shipping the corresponding object to a user's address. In some instances, the one or more fulfillment actions include actions performed by the user or another third party that are associated with completion of the transaction. For example, the fulfillment actions can include the user activating the virtual gift card, or a third party acknowledging delivery of the corresponding object to the user's mailing address.

A fulfillment action of the one or more fulfillment actions can include actions that are specific to a particular object. In some instances, the fulfillment actions for the particular object are different from fulfillment actions associated with other objects. For example, the fulfillment-tracking application 202 can detect that a virtual gift card has been activated, while monitoring shipment statuses for other physical objects of the set of objects. As a result, the fulfillment-tracking application 202 can monitor for various types of fulfillment actions that are specifically being performed for the set of objects.

In some instances, the fulfillment actions for a particular object can be associated with a time frame that can be different from similar fulfillment actions of other objects. For example, a shipment of an electronic device can be performed within two business days, but a shipment of a furniture can take more than two months. To accommodate for these differences, the fulfillment-tracking application 202 can use various conditions and thresholds to assess whether a given action successfully fulfills the transaction.

In some instances, the one or more fulfillment actions can be detected by analyzing signal data generated by a plurality of sensors. For example, the action-monitoring module 210 can communicate with an Internet of Things (IoT) sensor network of the web service 206 to receive signal data associated with the one or more fulfillment actions. The IoT sensor network can includes a sensor data layer that includes various IoT sensors that can measure physical surroundings and capture real-time environment changes. The IoT sensors can include temperature, pressure, humidity, level, accelerometer, gas, gyroscopes, motion sensors image, optical sensors, Radiofrequency Identifier (RFID) sensors, and Infra-Red (IR) sensors. The IoT sensors are mainly associated with the microprocessing unit, storage unit, control unit, power system and wireless communication interfaces. The IoT sensor devices are constrained in size, computing power, memory, networking capability and storage space. Wireless communication protocols, such as Wi-Fi, Zig Bee, Bluetooth, Near Frequency Communication (NFC) and LTE/4G mobile technologies, are used for IoT sensor device communication within the sensor network.

The IoT sensor network can further include a data fusion layer configured to process the sensor data generated by sensor devices of the sensor data layer. In particular, the data fusion layer can integrate the sensor data from the IoT sensor devices, which can be forwarded to the data analysis layer to identify the one or more fulfillment actions. In some instances, the data analysis layer implements data processing techniques to identify the one or more fulfillment actions from the integrated sensor data. Examples of the data processing techniques can include data denoising, missing data imputation (e.g., Gaussian model, spatial and temporal correlation, probabilistic matrix factorization), data outlier detection (e.g., principal component analysis), and data fusion (e.g., Bayesian method).

Once the one or more fulfillment actions are detected, an action-evaluation module 214 of the fulfillment-tracking application 202 can determine in real-time that fulfillment conditions associated with a subset of objects have been satisfied. For example, the fulfillment-tracking application 202 can determine that a completion of a shipment associated with a corresponding object satisfies a fulfillment condition. In another example, the fulfillment-tracking application 202 can further determine that an activation of a virtual gift card satisfies another fulfillment condition.

To identify the subset of objects, the action-evaluation module 214 can preprocess the one or more fulfillment actions in a structured data format, in which the structured data can include each of the one or more fulfillment actions being associated with a corresponding identifier, a type of fulfillment action, and objects of the transaction to which the fulfillment action is related. The action-evaluation module 214 can apply one or more data-processing rules to the structured data to identify the subset of objects that satisfy the fulfillment conditions. The action-evaluation module 214 can access the data-processing rules from a condition database 216, in which each of the data-processing rules is generated to determine whether fulfillment actions satisfy a corresponding condition.

In some instances, the satisfaction of the fulfillment conditions is determined in real-time as the plurality of fulfillment actions associated with the other objects continue to be received. For example, the action-evaluation module 214 can generate the structured data, apply the data-processing rules, and identify the subset of objects in real-time, as the action-monitoring module 210 continues to receive the plurality of fulfillment actions from various service providers (e.g., the web services 206). The non-static, real-time determination of fulfillment conditions can result in a rapid distribution of resources that are substantially more efficient than other conventional techniques that rely on passive collection of data over a given period of time.

In some instances, to determine the satisfaction of the fulfillment conditions, the action-evaluation module 214 applies a machine-learning model to the one or more fulfillment actions and domain data associated with the set of objects to generate an output indicating whether the fulfillment conditions have been satisfied. The action-evaluation module 214 can determine that the fulfillment conditions associated with the subset of objects have been satisfied based on the output. The domain data can be accessed from a domain database 218, in which the domain data can be used to determine various parameters associated with the fulfillment conditions (e.g., time required for shipment).

To apply the machine-learning model, a machine-learning model (e.g., LSTM, CNN) selected from a model database can be trained using a training dataset. The training dataset can include a plurality of previously-performed fulfillment actions and domain data, in which each of the previously-performed fulfillment actions can be associated with a corresponding label indicating whether the previously-performed fulfillment action satisfies one or more conditions associated with a corresponding domain. The training of the machine-learning model can be performed until a corresponding loss (e.g., a mean square error) reaches a minimum threshold. The trained machine-learning model can then be provided to the action-evaluation module 214, which can apply the trained machine-learning model to the one or more fulfillment actions to identify the subset of objects that satisfy the fulfillment conditions.

The machine-learning model may be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. Techniques for using machine-learning models to determine the subset of objects are further described in Section II of the present disclosure.

After the action-evaluation module 214 determines that fulfillment conditions associated with a subset of objects have been satisfied, a metric generator 220 of the fulfillment-tracking application 202 can identify a fulfillment metric associated with the subset of objects. The fulfillment metric can include any type of value that represent one or more characteristics associated with the subset of objects. For example, the fulfillment metric can be determined to represent a cumulative characteristic of the subset of objects. In some instances, the fulfillment metric includes a statistical value associated with the subject of objects. For example, the fulfillment metric includes a total pecuniary value (e.g., a total dollar amount) corresponding to the subset of objects. In another example, the fulfillment metric can include a count of objects corresponding to the subset of objects (e.g., 4 objects). Other examples of the fulfillment metric can include an average pecuniary value and a median pecuniary value. In some instances, the fulfillment metric includes any percentage value derived from one or more of the above values. For example, the fulfillment metric can be 0.5 if the count of the subset of objects is 4 while the count of the total number of objects is 8. Additionally or alternatively, the fulfillment metric can include a time-based metric associated with the subject of objects. For example, the fulfillment metric can include a time point at which the fulfillment conditions have been satisfied.

A metric-evaluation module 222 of the fulfillment-tracking application 202 can compare the fulfillment metric with a predetermined threshold. The predetermined threshold includes any values that can be used for determining whether the fulfillment for the subset of objects qualifies for distribution of the resources by the resource provider 204. In some instances, the metric-evaluation module 222 determines the predetermined threshold based on a type of fulfillment metric that represents the subset of objects. For example, if the fulfillment metric corresponds to a total pecuniary value of the subset of objects (e.g., 550 USD), the predetermined threshold can be a percentage of the total pecuniary value of the set of objects (e.g., 75% of 600 USD). In another example, if the fulfillment metric corresponds to a time point at which the fulfillment conditions have been satisfied (e.g., 35 days after the transaction), the predetermined threshold can be an elapsed time from a time point at which the request for the distribution of resources was received (e.g., 30 days).

In some instances, the metric-evaluation module 222 determines the predetermined threshold based on the domain data associated with the set of objects. In some instances, the predetermined threshold relating to the elapsed time corresponds to a first value for a first domain, a second value for a second domain, a third value for a third domain, and so on. The predetermined thresholds are different across various domains, because a particular value that is relevant for assessing fulfillment conditions for a particular domain can be less relevant for other domains. As an illustrative example relating to fulfillment metrics corresponding to the elapsed time, a predetermined threshold relating to transactions involving furniture can be 6 months, whereas another predetermined threshold relating to transactions involving electronic devices can be 90 days. In another example relating to fulfillment metrics corresponding to account of the subset of objects, a predetermined threshold relating to transactions involving furniture can be 80% of the total count of objects (since there is a likelihood of a shipment delay), whereas another predetermined threshold relating to transactions involving electronic devices can be 100%.

Additionally or alternatively, the predetermined threshold can be determined based on the domain data from two or more domains. In particular, the metric-evaluation module 222 can determine the predetermined threshold based on the domain associated with an object having the highest pecuniary value. For example, if the transaction includes a purchase of a shirt and a mattress, the metric-evaluation module 222 can determine the predetermined threshold based on domain data associated with the furniture items. In some instances, the metric-evaluation module 222 determines the predetermined threshold based on the domain of an object having a shorter fulfillment period. For example, if the transaction includes a purchase of a gaming laptop and a mattress, the metric-evaluation module 222 can determine the predetermined threshold based on domain data associated with the electronic device, as the mattress takes the longer time for shipment (e.g., 3 months) relative to the gaming laptop (e.g., 2 days).

In some instances, to determine whether the fulfillment metric qualifies for the distribution of the resources, the metric-evaluation module 222 can apply another machine-learning model to the fulfillment metric and the corresponding domain data associated with the set of objects. The other machine-learning model can then generate an output indicating whether the fulfillment metric qualifies for the distribution of the resources. For example, the output can include a binary value indicating whether the resources should be distributed. In another example, the output can include a numerical value, at which the metric-evaluation module can compare the numerical value to a confidence threshold to determine whether the resources should be distributed.

To apply the other machine-learning model, a machine-learning model (e.g., LSTM, CNN) selected from a model database can be trained using a training dataset. The training dataset can include fulfillment metrics determined from previous transactions and domain data, in which each of the fulfillment metrics can be associated with a corresponding label indicating whether the resources have been distributed for the corresponding transaction. The training of the other machine-learning model can be performed until a corresponding loss (e.g., a mean square error) reaches a minimum threshold. The other trained machine-learning model can then be provided to the metric-evaluation module 222, which can apply the other trained machine-learning model to the fulfillment metric for the subset of objects to determine whether the resources should be distributed to the web service 206 and/or other service providers associated with the transaction.

The other machine-learning model may also be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. Techniques for using machine-learning models to process the fulfillment metrics are further described in Section III of the present disclosure.

If the metric-evaluation module 222 determines that the fulfillment metric exceeds the predetermined threshold, a transaction processor 224 of the fulfillment-tracking application 202 distributes the resources to the web service 206 and/or any other services identified in the request. For example, if the metric-evaluation module 222 determines that three out of five objects (e.g., a total count of the subset) being shipped to the user exceeds the predetermined threshold of 2, the transaction processor 224 can proceed with distributing the resources associated with the transaction. In some instances, the fulfillment-tracking application 202 can generate a notification indicating that the resources were distributed by the transaction processor 224. In some instances, if the request includes a request for distributing the resources across multiple service providers that participated in the transaction, the transaction processor 224 automatically provides portions of the resources to the respective service providers. For example, if the request identifies the web service 206 and a delivery service provider, the transaction processor 224 can distribute a first portion of the resources to the web service 206 and a second portion of the resources to the delivery service provider.

In some instances, if the metric-evaluation module 222 determines that the fulfillment metric does not exceed the predetermined threshold, the transaction processor 224 adjusts an amount of resources to be distributed to the web service 206 and/or any other services identified in the request. The transaction processor 224 can then distribute the resources using the adjusted amount of resources. For example, if the transaction involves 5 objects and only a single object has been shipped to the user, the metric-evaluation module 22 can determine that fulfillment metric corresponding to a single object does not exceed the predetermined threshold of 3. Continuing with the example, the transaction processor 224 can adjust the amount of resources corresponding to the single object that has been shipped to the user and distribute the adjusted amount to the web service 206.

Additionally or alternatively, if the metric-evaluation module 222 determines that the fulfillment metric does not exceed the predetermined threshold, the transaction processor 224 can repeat the data collection steps and monitor for additional fulfillment actions associated with remaining objects of the set of objects. With reference to the previous example, if the transaction involves 5 objects and only a single object has been shipped to the user, the metric-evaluation module 222 can determine that fulfillment metric corresponding to a single object does not exceed the predetermined threshold of 3. Instead of adjusting the amount of resources to be distributed to the entity, the transaction processor 224 can transmit instructions to the action-monitoring module 210 to return to monitoring for additional fulfillment actions to be performed for remaining objects of the set of objects.

### C. System Components and Special-Purpose Computer for Tracking Fulfillment Statuses of Objects Associated With Transactions

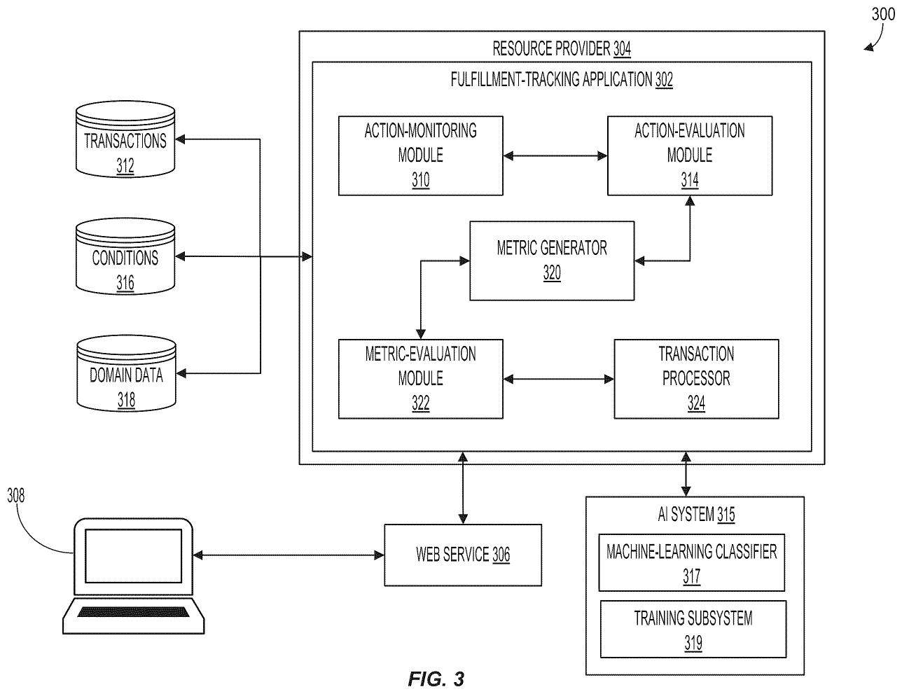

FIG. 3 illustrates an example computing environment 300 that includes a special-purpose computer configured to track fulfillment statuses of objects associated with transactions, according to some embodiments. In the computing environment 300, a fulfillment-tracking application 302 of a resource provider 304 (e.g., a financial institution) can receive a request for distribution of resources from a web service 306. In some instances, the resources are associated with a transaction to be fulfilled by an entity associated with the web service 306 (e.g., a merchant website) and/or other third-party services, in which the resources can include any tangible or intangible assets that can be exchanged for performance of the transaction. The transaction can include any interaction in which a user of a user device 308 transfers resources with the entity to obtain goods or services. In some embodiments, the resource provider 304 provides the resources to the web service 306, after the web service 306 successfully fulfills the transaction on behalf of the user of the user device 308. For example, the web service 306 can authorize the transaction associated with the user in exchange for the resource provider 304 providing the corresponding resources. To receive the resources, the web service 306 can generate the request after the transaction has been authorized for the user of the user device 308, at which the resource provider 304 can track whether the web service 306 has fulfilled the transaction. In some instances, the request includes a request for distributing the resources across multiple service providers that participated in the transaction. For example, the web service 306 and a delivery service provider can be both identified in the request, such that a first portion of the resources is distributed to the web service 306 while a second portion of the resources is distributed to the delivery service provider. The above example is for illustration purposes only, and the number of service providers identified in the request can include 1, 2, 3, 4, 5, 10, 15, 20, or more than 20 service providers.

The fulfillment-tracking application 302 can receive and communicate with the web service 306 across a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

In some instances, the fulfillment-tracking application 302 communicates with the web service 306 by using application programming interfaces (APIs). For example, the request can be transmitted by the web service 306 using an API protocol such as Hypertext Markup Language (HTML), Extensible Markup Language (XML), JavaScript®, Cascading Style Sheets (CSS), JavaScript® Object Notation (JSON), and other such protocols and/or structured languages. The API request transmitted by the web service 306 can include an identifier associated with the transaction, account data associated with the user, additional details associated with the transaction (e.g., purchased objects, a total amount of transaction, merchant identifier associated with the web service 306, identifiers associated with third-party service providers that participated in the transaction), an amount requested for distribution, and one or more actions performed by the web service 306 to fulfill the transaction. The fulfillment-tracking application 302 can parse the API request to generate an API response, which can include the requested resources, an adjusted amount from the requested resources, or a message indicating that the resources cannot be distributed until successful fulfillment of the corresponding transaction.

The transaction can be associated with a set of objects. The objects can be physical objects, intangible objects such as pecuniary values or intellectual property, and/or services. For example, an object can be a tangible object such as an electronic device, and another object can be an intangible object such as a video file, downloadable video game, or a music file. The fulfillment-tracking application 302 can identify each of the set of objects by concatenating the transaction identifier with a corresponding object identifier for the object. As an illustrative example associated with the transaction, the transaction can include a purchase of five objects, in which the resources are distributed by the resource provider 304 once the entity completes fulfillment (e.g., shipping) of the five objects. Depending on the domain and/or data-processing rules set by the resource provider, the resources can be distributed even if all five objects have not yet been fulfilled (e.g., only three items were shipped) by the web service 306. In some embodiments, the set of objects for a single transaction includes at least 2, 3, 4, 5, 10, 15, 20, or more than 20 objects. The set of objects can correspond to the same object in multiple quantities. In some instances, an object of the set is different from at least another object in the set. For example, an object of the set can be an intangible object (e.g., virtual gift card), whereas another object can be a tangible object (e.g., a clothing item).

The fulfillment-tracking application 302 can be implemented by a computer system, which can take any suitable physical form. As example and not by way of limitation, the computer system of the resource provider 304 can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider (e.g., the computing resources provider 728).

The fulfillment-tracking application 302 can include various modules or components to track fulfillments in various transactions. With reference to FIG. 3, the fulfillment-tracking application 302 can include an action-monitoring module 310 that detects in real-time one or more fulfillment actions associated with the set of objects. The action-monitoring module 310 can detect one or more fulfillment actions in real-time as a plurality of fulfillment actions associated with other objects are being received. For example, the action-monitoring module 310 can parse data transmitted by the web service 306 and/or other service providers in real-time to identify the plurality of fulfillment actions, identify in real-time the one or more fulfillment actions from the plurality of fulfillment actions, and associate in real-time the one or more fulfillment actions with objects associated with the transaction of the request. Additionally or alternatively, the action-monitoring module 310 can perform the above operations in real-time by associating each fulfillment action of the plurality of fulfillment actions with a corresponding transaction identifier stored in a transactions database 312. In effect, the non-static, real-time detection of the one or more fulfillment actions can result in an output at a particular time point being different from other outputs generated based on other fulfillment actions detected in different time points (e.g., 10 seconds later, 30 seconds later, 1 minute later, 5 minutes later, 10 minutes later).

The one or more fulfillment actions can include any actions performed by the web service 306 to complete and fulfill the transaction for the user of the user device 308. In some instances, the one or more fulfillment actions correspond to at least one object of the set of objects. For example, the fulfillment actions can include retrieving a corresponding object from a product warehouse or shipping the corresponding object to a user's address. In some instances, the one or more fulfillment actions include actions performed by the user or another third party that are associated with completion of the transaction. For example, the fulfillment actions can include the user activating the virtual gift card, or a third party acknowledging delivery of the corresponding object to the user's mailing address.

A fulfillment action of the one or more fulfillment actions can include actions that are specific to a particular object. In some instances, the fulfillment actions for the particular object are different from fulfillment actions associated with other objects. For example, the fulfillment-tracking application 302 can detect that a virtual gift card has been activated, while monitoring shipment statuses for other physical objects of the set of objects. As a result, the fulfillment-tracking application 302 can monitor for various types of fulfillment actions that are specifically being performed for the set of objects.

In some instances, the fulfillment actions for a particular object can be associated with a time frame that can be different from similar fulfillment actions of other objects. For example, a shipment of an electronic device can be performed within two business days, but a shipment of a furniture can take more than two months. To accommodate for these differences, the fulfillment-tracking application 302 can use various conditions and thresholds to assess whether a given action successfully fulfills the transaction.

In some instances, the one or more fulfillment actions can be detected by analyzing signal data generated by a plurality of sensors. For example, the action-monitoring module 310 can communicate with an Internet of Things (IoT) sensor network of the web service 306 to receive signal data associated with the one or more fulfillment actions. The IoT sensor network can includes a sensor data layer that includes various IoT sensors that can measure physical surroundings and capture real-time environment changes. The IoT sensors can include temperature, pressure, humidity, level, accelerometer, gas, gyroscopes, motion sensors image, optical sensors, Radiofrequency Identifier (RFID) sensors, and Infra-Red (IR) sensors. The IoT sensors are mainly associated with the microprocessing unit, storage unit, control unit, power system and wireless communication interfaces. The IoT sensor devices are constrained in size, computing power, memory, networking capability and storage space. Wireless communication protocols, such as Wi-Fi, Zig Bee, Bluetooth, Near Frequency Communication (NFC) and LTE/4G mobile technologies, are used for IoT sensor device communication within the sensor network.

The IoT sensor network can further include a data fusion layer configured to process the sensor data generated by sensor devices of the sensor data layer. In particular, the data fusion layer can integrate the sensor data from the IoT sensor devices, which can be forwarded to the data analysis layer to identify the one or more fulfillment actions. In some instances, the data analysis layer implements data processing techniques to identify the one or more fulfillment actions from the integrated sensor data. Examples of the data processing techniques can include data denoising, missing data imputation (e.g., Gaussian model, spatial and temporal correlation, probabilistic matrix factorization), data outlier detection (e.g., principal component analysis), and data fusion (e.g., Bayesian method).

Once the one or more fulfillment actions are detected, an action-evaluation module 314 of the fulfillment-tracking application 302 can determine in real-time that fulfillment conditions associated with a subset of objects have been satisfied. For example, the fulfillment-tracking application 302 can determine that a completion of a shipment associated with a corresponding object satisfies a fulfillment condition. In another example, the fulfillment-tracking application 302 can further determine that an activation of a virtual gift card satisfies another fulfillment condition.

To identify the subset of objects, the action-evaluation module 314 can preprocess the one or more fulfillment actions in a structured data format, in which the structured data can include each of the one or more fulfillment actions being associated with a corresponding identifier, a type of fulfillment action, and objects of the transaction to which the fulfillment action is related. The action-evaluation module 314 can apply one or more data-processing rules to the structured data to identify the subset of objects that satisfy the fulfillment conditions. The action-evaluation module 314 can access the data-processing rules from a condition database 316, in which each of the data-processing rules is generated to determine whether fulfillment actions satisfy a corresponding condition.

In some instances, the satisfaction of the fulfillment conditions is determined in real-time as the plurality of fulfillment actions associated with the other objects continue to be received. For example, the action-evaluation module 314 can generate the structured data, apply the data-processing rules, and identify the subset of objects in real-time, as the action-monitoring module 310 continues to receive the plurality of fulfillment actions from various service providers (e.g., the web services 306). The non-static, real-time determination of fulfillment conditions can result in a rapid distribution of resources that are substantially more efficient than other conventional techniques that rely on passive collection of data over a given period of time.

In some instances, to determine the satisfaction of the fulfillment conditions, the action-evaluation module 314 applies a machine-learning model to the one or more fulfillment actions and domain data associated with the set of objects to generate an output indicating whether the fulfillment conditions have been satisfied. The action-evaluation module 314 can determine that the fulfillment conditions associated with the subset of objects have been satisfied based on the output. The domain data can be accessed from a domain database 318, in which the domain data can be used to determine various parameters associated with the fulfillment conditions (e.g., time required for shipment).

In some instances, the action-evaluation module 314 transmits the one or more fulfillment actions and the domain data associated with the set of objects to an AI system 315, which can apply the machine-learning model to the above data to generate the output indicating whether the fulfillment conditions have been satisfied. In some embodiments, the AI system 315 is implemented by a special purpose computer that is specifically configured to process the one or more fulfillment actions and generate outputs that can be used to determine the subset of objects that satisfy the fulfillment conditions. Additionally, one or more components of the AI system 315 can be implemented by another special purpose computer (e.g., a training subsystem 319), which can be specifically configured to train the machine-learning model using the plurality of previously-performed fulfillment actions and domain data to determine the subset of objects.

To apply the machine-learning model, a training subsystem 319 can select the machine-learning model (e.g., LSTM, CNN) from a model database and train the selected machine-learning model using a training dataset. The training dataset can include the plurality of previously-performed fulfillment actions and the domain data, in which each of the previously-performed fulfillment actions can be associated with a corresponding label indicating whether the previously-performed fulfillment action satisfies one or more conditions associated with a corresponding domain. The training subsystem 319 can train the machine-learning model until a corresponding loss (e.g., a mean square error) reaches a minimum threshold. The training subsystem 319 can provide the trained machine-learning model to the machine-learning classifier 317, which can apply the trained machine-learning model to the one or more fulfillment actions to generate the output. The machine-learning classifier 317 can transmit the output to the action-evaluation module 314, which can use the output to identify the subset of objects that satisfy the fulfillment conditions.

The machine-learning model may be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. Techniques for using machine-learning models to determine the subset of objects are further described in Section II of the present disclosure.

After the action-evaluation module 314 determines that fulfillment conditions associated with a subset of objects have been satisfied, a metric generator 320 of the fulfillment-tracking application 302 can identify a fulfillment metric associated with the subset of objects. The fulfillment metric can include any type of value that represent one or more characteristics associated with the subset of objects. For example, the fulfillment metric can be determined to represent a cumulative characteristic of the subset of objects. In some instances, the fulfillment metric includes a statistical value associated with the subject of objects. For example, the fulfillment metric includes a total pecuniary value (e.g., a total dollar amount) corresponding to the subset of objects. In another example, the fulfillment metric can include a count of objects corresponding to the subset of objects (e.g., 4 objects). Other examples of the fulfillment metric can include an average pecuniary value and a median pecuniary value. In some instances, the fulfillment metric includes any percentage value derived from one or more of the above values. For example, the fulfillment metric can be 0.5 if the count of the subset of objects is 4 while the count of the total number of objects is 8. Additionally or alternatively, the fulfillment metric can include a time-based metric associated with the subject of objects. For example, the fulfillment metric can include a time point at which the fulfillment conditions have been satisfied.

A metric-evaluation module 322 of the fulfillment-tracking application 302 can compare the fulfillment metric with a predetermined threshold. The predetermined threshold includes any values that can be used for determining whether the fulfillment for the subset of objects qualifies for distribution of the resources by the resource provider 304. In some instances, the metric-evaluation module 322 determines the predetermined threshold based on a type of fulfillment metric that represents the subset of objects. For example, if the fulfillment metric corresponds to a total pecuniary value of the subset of objects (e.g., 550 USD), the predetermined threshold can be a percentage of the total pecuniary value of the set of objects (e.g., 75% of 600 USD). In another example, if the fulfillment metric corresponds to a time point at which the fulfillment conditions have been satisfied (e.g., 35 days after the transaction), the predetermined threshold can be an elapsed time from a time point at which the request for the distribution of resources was received (e.g., 30 days).

In some instances, the metric-evaluation module 322 determines the predetermined threshold based on the domain data associated with the set of objects. In some instances, the predetermined threshold relating to the elapsed time corresponds to a first value for a first domain, a second value for a second domain, a third value for a third domain, and so on. The predetermined thresholds are different across various domains, because a particular value that is relevant for assessing fulfillment conditions for a particular domain can be less relevant for other domains. As an illustrative example relating to fulfillment metrics corresponding to the elapsed time, a predetermined threshold relating to transactions involving furniture can be 6 months, whereas another predetermined threshold relating to transactions involving electronic devices can be 90 days. In another example relating to fulfillment metrics corresponding to account of the subset of objects, a predetermined threshold relating to transactions involving furniture can be 80% of the total count of objects (since there is a likelihood of a shipment delay), whereas another predetermined threshold relating to transactions involving electronic devices can be 100%.

Additionally or alternatively, the predetermined threshold can be determined based on the domain data from two or more domains. In particular, the metric-evaluation module 322 can determine the predetermined threshold based on the domain associated with an object having the highest pecuniary value. For example, if the transaction includes a purchase of a shirt and a mattress, the metric-evaluation module 322 can determine the predetermined threshold based on domain data associated with the furniture items. In some instances, the metric-evaluation module 322 determines the predetermined threshold based on the domain of an object having a shorter fulfillment period. For example, if the transaction includes a purchase of a gaming laptop and a mattress, the metric-evaluation module 322 can determine the predetermined threshold based on domain data associated with the electronic device, as the mattress takes the longer time for shipment (e.g., 3 months) relative to the gaming laptop (e.g., 2 days).

In some instances, to determine whether the fulfillment metric qualifies for the distribution of the resources, the metric-evaluation module 322 can apply another machine-learning model to the fulfillment metric and the corresponding domain data associated with the set of objects. The other machine-learning model can then generate an output indicating whether the fulfillment metric qualifies for the distribution of the resources. For example, the output can include a binary value indicating whether the resources should be distributed. In another example, the output can include a numerical value, at which the metric-evaluation module can compare the numerical value to a confidence threshold to determine whether the resources should be distributed.

The metric-evaluation module 322 can also transmit the fulfillment metric and the domain data associated with the set of objects to the AI system 315, which can apply the machine-learning model to the above data to generate the output indicating whether the fulfillment metric qualifies for the distribution of the resources. To apply the other machine-learning model, the training subsystem 319 can select a machine-learning model (e.g., LSTM, CNN) selected from the model database and train the machine-learning model using a training dataset. The training dataset can include fulfillment metrics determined from previous transactions and domain data, in which each of the fulfillment metrics can be associated with a corresponding label indicating whether the resources have been distributed for the corresponding transaction. The training subsystem 319 can train the other machine-learning model until a corresponding loss (e.g., a mean square error) reaches a minimum threshold. The training subsystem 319 can then provide the other trained machine-learning model to the machine-learning classifier 317, which can apply the other trained machine-learning model to the fulfillment metric for the subset of objects to generate an output (e.g., the binary value, the numerical value). The output from the machine-learning classifier 317 can then be used by the metric-evaluation module 322 to determine whether the resources should be distributed to the web service 306 and/or other service providers associated with the transaction.

The other machine-learning model may also be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. Techniques for using machine-learning models to process the fulfillment metrics are further described in Section III of the present disclosure.

If the metric-evaluation module 322 determines that the fulfillment metric exceeds the predetermined threshold, a transaction processor 324 of the fulfillment-tracking application 302 distributes the resources to the web service 306 and/or any other services identified in the request. For example, if the metric-evaluation module 322 determines that three out of five objects (e.g., a total count of the subset) being shipped to the user exceeds the predetermined threshold of 2, the transaction processor 324 can proceed with distributing the resources associated with the transaction. In some instances, the fulfillment-tracking application 302 can generate a notification indicating that the resources were distributed by the transaction processor 324. In some instances, if the request includes a request for distributing the resources across multiple service providers that participated in the transaction, the transaction processor 324 automatically provides portions of the resources to the respective service providers. For example, if the request identifies the web service 306 and a delivery service provider, the transaction processor 324 can distribute a first portion of the resources to the web service 306 and a second portion of the resources to the delivery service provider.

In some instances, if the metric-evaluation module 322 determines that the fulfillment metric does not exceed the predetermined threshold, the transaction processor 324 adjusts an amount of resources to be distributed to the web service 306 and/or any other services identified in the request. The transaction processor 324 can then distribute the resources using the adjusted amount of resources. For example, if the transaction involves 5 objects and only a single object has been shipped to the user, the metric-evaluation module 32 can determine that fulfillment metric corresponding to a single object does not exceed the predetermined threshold of 3. Continuing with the example, the transaction processor 324 can adjust the amount of resources corresponding to the single object that has been shipped to the user and distribute the adjusted amount to the web service 306.

Additionally or alternatively, if the metric-evaluation module 322 determines that the fulfillment metric does not exceed the predetermined threshold, the transaction processor 324 can repeat the data collection steps and monitor for additional fulfillment actions associated with remaining objects of the set of objects. With reference to the previous example, if the transaction involves 5 objects and only a single object has been shipped to the user, the metric-evaluation module 322 can determine that fulfillment metric corresponding to a single object does not exceed the predetermined threshold of 3. Instead of adjusting the amount of resources to be distributed to the entity, the transaction processor 324 can transmit instructions to the action-monitoring module 310 to return to monitoring for additional fulfillment actions to be performed for remaining objects of the set of objects.

### D. Methods for Tracking Fulfillment Statuses of Objects Associated With Transactions

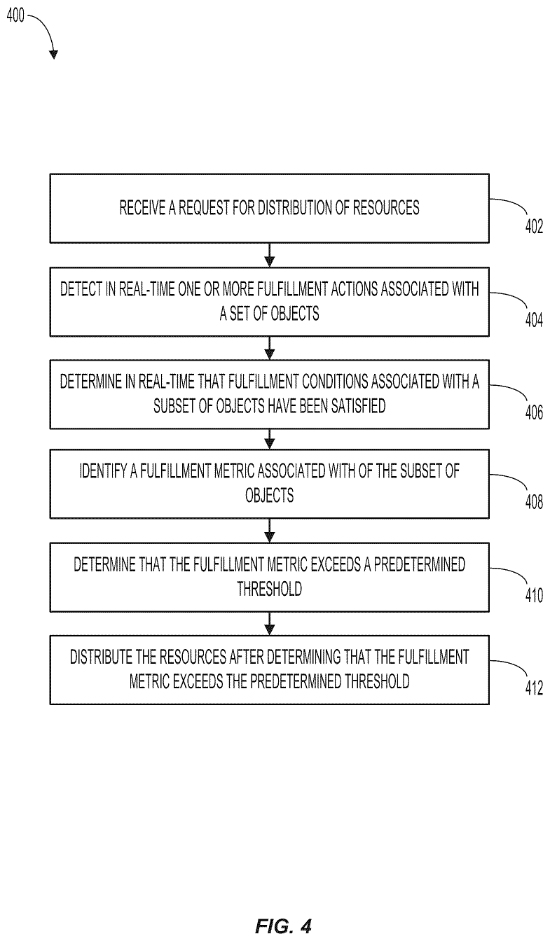

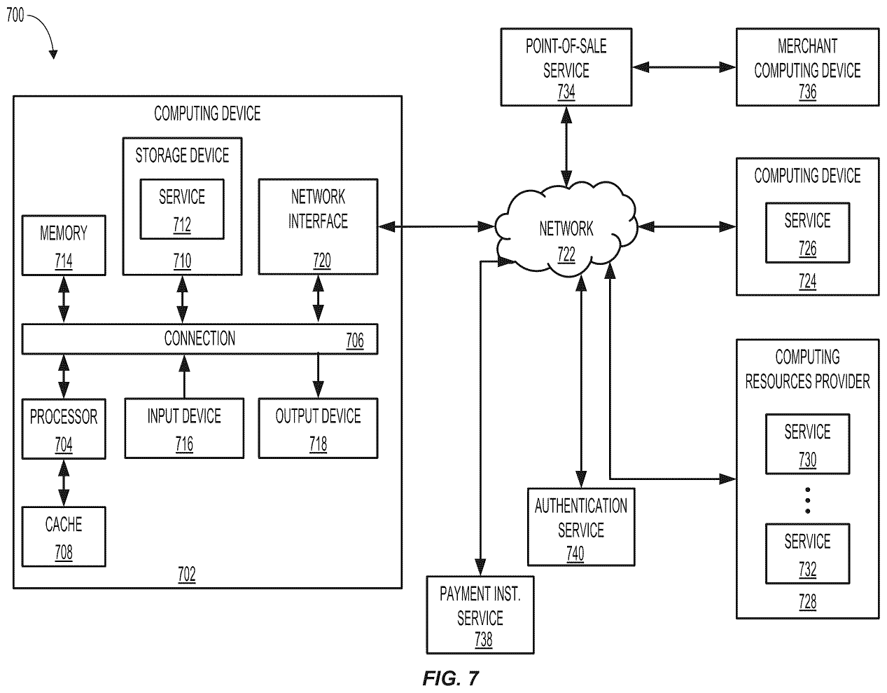

FIG. 4 shows an illustrative example of a process 400 for tracking fulfillment statuses of objects associated with transactions, in accordance with some embodiments. For illustrative purposes, the process 400 is described with reference to the components illustrated in FIGS. 2-3, though other implementations are possible. For example, the program code for the fulfillment-tracking application 202 of FIG. 2, is executed by one or more processing devices to cause a server system (e.g., the computing device 702 of FIG. 7) to perform one or more operations described herein.

At step 402, a fulfillment-tracking application (e.g., the fulfillment-tracking application 202 of FIG. 2) receives a request for distribution of resources. In some instances, the resources are associated with a transaction to be fulfilled by an entity. The transaction can include any interaction in which a user transfers resources with the entity to obtain goods or services. In some instances, the resources include any tangible or intangible assets that can be exchanged for performance of the transaction. In some embodiments, a resource provider provides the resources to the entity, after the entity successfully fulfills the transaction on behalf of the user. For example, the entity can authorize the transaction associated with a user in exchange for a resource provider providing the corresponding resources. To receive the resources, the entity can generate the request after the transaction has been authorized for the user.

The transaction can be associated with a set of objects. The objects can be physical objects, intangible objects such as pecuniary values or intellectual property, and/or services. For example, the transaction can include a purchase of five objects, in which the resources are distributed by the resource provider once the entity completes fulfillment (e.g., shipping) of the five objects. Depending on the domain and/or data-processing rules set by the resource provider, the resources can be distributed even if all five objects have not yet been fulfilled (e.g., only three items were shipped). The set of objects for a single transaction can include at least 2, 3, 4, 5, 10, 15, 20, or more than 20 objects. The set of objects can correspond to the same object in multiple quantities. In some instances, an object of the set is different from at least another object in the set. For example, an object of the set can be an intangible object (e.g., virtual gift card), whereas another object can be a physical object (e.g., a clothing item).

At step 404, the fulfillment-tracking application detects in real-time one or more fulfillment actions associated with the set of objects. The one or more fulfillment actions can be detected in real-time as a plurality of fulfillment actions associated with other objects are being received. In effect, the non-static, real-time detection of the one or more fulfillment actions can result in an output at a particular time point being different from other outputs generated based on other fulfillment actions detected in different time points (e.g., 10 seconds later, 30 seconds later, 1 minute later, 5 minutes later, 10 minutes later). In some instances, the one or more fulfillment actions can be detected by analyzing signal data generated by a plurality of sensors.

The one or more fulfillment actions can include any actions performed by the entity to complete and fulfill the transaction for the user. In some instances, the one or more fulfillment actions correspond to at least one object of the set of objects. For example, the fulfillment actions can include retrieving a corresponding object from a product warehouse or shipping the corresponding object to a user's address. In some instances, the one or more fulfillment actions can include actions performed by the user or another third party that are associated with completion of the transaction. For example, the fulfillment actions can include the user activating the virtual gift card, or a third party acknowledging delivery of the corresponding object to the user's mailing address.

A fulfillment action can include actions that are specific to a particular object. In some instances, the fulfillment actions for the particular object are different from fulfillment actions of other objects. For example, the fulfillment-tracking application can detect that a virtual gift card has been activated, while monitoring shipments for other physical objects of the set of objects. As a result, the fulfillment-tracking application can monitor for various types of fulfillment actions that are specifically being performed for the set of objects.

In some instances, the fulfillment actions for a particular object can be associated with a time frame that can be different from similar fulfillment actions of other objects. For example, a shipment of an electronic device can be performed within two business days, but a shipment of a furniture can take more than two months. To accommodate for these differences, the fulfillment-tracking application can use various conditions and thresholds to assess whether a given action successfully fulfills the transaction.

At step 406, the fulfillment-tracking application determines in real-time that fulfillment conditions associated with a subset of objects have been satisfied. In some instances, the satisfaction of the fulfillment conditions is determined in real-time as the plurality of fulfillment actions associated with the other objects are being received. In addition, the satisfaction of the fulfillment conditions can be determined based on the one or more fulfillment actions. For example, the fulfillment-tracking application can determine that a completion of a shipment associated with a corresponding object satisfies a fulfillment condition and further determine that an activation of a virtual gift card satisfies another fulfillment condition. The non-static, real-time determination of fulfillment conditions can result in a rapid distribution of resources that are substantially more efficient than other conventional techniques that rely on passive collection of data over a given period of time.

To identify the subset of objects, the fulfillment-tracking application 102 can preprocess the one or more fulfillment actions in a structured data format, in which the structured data can include each of the one or more fulfillment actions being associated with a corresponding identifier, a type of fulfillment action, and objects (e.g., the object 112A) of the transaction to which the fulfillment action is related. The fulfillment-tracking application 102 can apply one or more data-processing rules to the structured data to identify the subset of objects that satisfy the fulfillment conditions. The fulfillment-tracking application 102 can access the data-processing rules from a condition database, in which each of the data-processing rules is generated to determine whether fulfillment actions satisfy a corresponding condition.

In some instances, to determine the satisfaction of the fulfillment conditions, the fulfillment-tracking application applies a machine-learning model to the one or more fulfillment actions and domain data associated with the set of objects to generate an output indicating whether the fulfillment conditions have been satisfied. The fulfillment-tracking application can determine that the fulfillment conditions associated with the subset of objects have been satisfied based on the output. The machine-learning model may be any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

At step 408, the fulfillment-tracking application identifies a fulfillment metric associated with the subset of objects. The fulfillment metric can include any type of value that represent one or more characteristics associated with the subset of objects. In some instances, the fulfillment metric includes a statistical value associated with the subject of objects. For example, the fulfillment metric includes a total pecuniary value (e.g., a total dollar amount) corresponding to the subset of objects. In another example, the fulfillment metric can include a count of objects corresponding to the subset of objects (e.g., 4 objects). Additionally or alternatively, the fulfillment metric can include a time-based metric associated with the subject of objects. For example, the fulfillment metric can include a time point at which the fulfillment conditions have been satisfied.

At step 410, the fulfillment-tracking application determines that the fulfillment metric exceeds a predetermined threshold. The fulfillment-tracking application can determine the predetermined threshold based on a type of fulfillment metric that represents the subset of objects. For example, if the fulfillment metric corresponds to a total pecuniary value of the subset of objects (e.g., 550 USD), the predetermined threshold can be a percentage of the total pecuniary value of the set of objects (e.g., 75% of 600 USD). In another example, if the fulfillment metric corresponds to a time point at which the fulfillment conditions have been satisfied (e.g., 35 days after the transaction), the predetermined threshold can be an elapsed time from a time point at which the request for the distribution of resources was received (e.g., 30 days).

In some instances, the predetermined threshold is determined based on domain data associated with the set of objects. In some instances, the predetermined threshold relating to the elapsed time corresponds to a first value for a first domain, a second value for a second domain, a third value for a third domain, and so on. The predetermined thresholds are different across various domains, because a particular value that is relevant for assessing fulfillment conditions for a particular domain can be less relevant for other domains. As an illustrative example relating to fulfillment metrics corresponding to the elapsed time, a predetermined threshold relating to transactions involving furniture can be 6 months, whereas another predetermined threshold relating to transactions involving electronic devices can be 90 days. In another example relating to fulfillment metrics corresponding to account of the subset of objects, a predetermined threshold relating to transactions involving furniture can be 80% of the total count of objects (since there is a likelihood of a shipment delay), whereas another predetermined threshold relating to transactions involving electronic devices can be 100%.

At step 412, the fulfillment-tracking application distributes the resources after determining that the fulfillment metric exceeds the predetermined threshold. For example, if the fulfillment-tracking application determines that three out of five objects (e.g., a total count of the subset) have been shipped to the user, the fulfillment-tracking application can proceed with distributing the resources associated with the transaction. In some instances, the fulfillment-tracking application can generate a notification indicating the distribution of the resources.

In some instances, if the fulfillment-tracking application determines that the fulfillment metric does not exceed the predetermined threshold, the fulfillment-tracking application adjusts an amount of resources to be distributed after determining that the fulfillment metric does not exceed the predetermined threshold. The fulfillment-tracking application can then distribute the resources using the adjusted amount of resources. For example, if the transaction involves 5 objects and only a single object has been shipped to the user, the fulfillment-tracking application can determine that fulfillment metric corresponding to a single object does not exceed the predetermined threshold of three objects. Continuing with the example, the fulfillment-tracking application can adjust the amount of resources corresponding to the single object that has been shipped to the user.

Additionally or alternatively, if the fulfillment-tracking application determines that the fulfillment metric does not exceed the predetermined threshold, the fulfillment-tracking application can repeat the data collection steps (e.g., steps 404-406) and monitor for additional fulfillment actions associated with the set of objects after determining that the fulfillment metric does not exceed the predetermined threshold. With reference to the previous example, if the transaction involves 5 objects and only a single object has been shipped to the user, the fulfillment-tracking application can determine that fulfillment metric corresponding to a single object does not exceed the predetermined threshold of three objects. Instead of adjusting the amount of resources to be distributed to the entity, the fulfillment-tracking application can return to monitoring for additional fulfillment actions to be performed for the set of objects. Process 400 terminates thereafter.

### II. MACHINE-LEARNING TECHNIQUES FOR TRACKING FULFILLMENT CONDITIONS

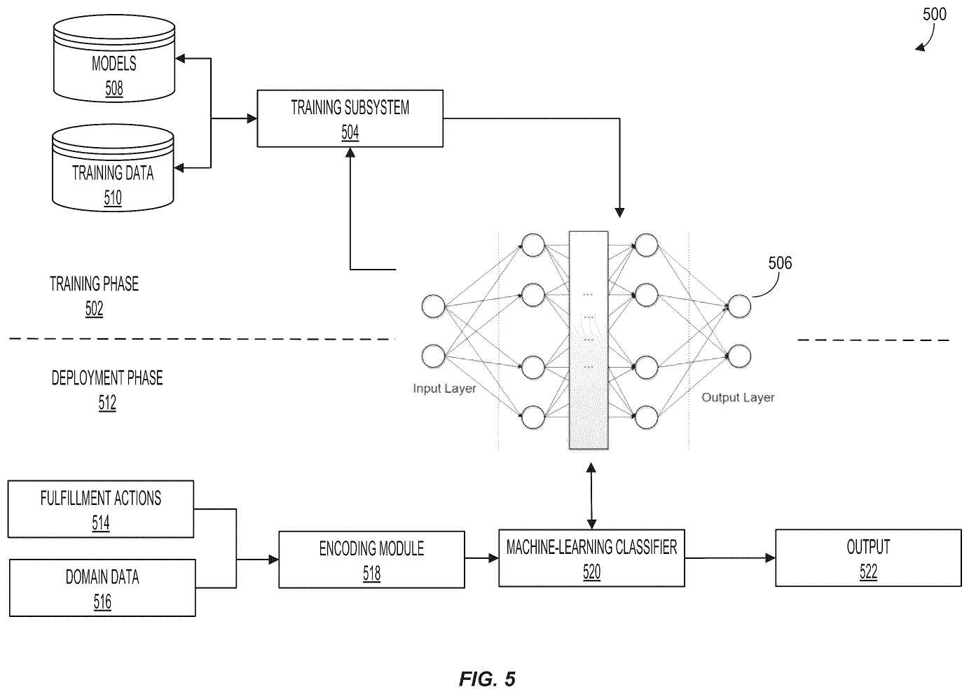

A machine-learning model can be trained to determine a subset of a set of objects that satisfy their respective fulfillment conditions. FIG. 5 illustrates an example schematic diagram 500 for tracking fulfillment conditions, according to some embodiments. As described herein, a fulfillment-tracking application (e.g., the fulfillment-tracking application 202 of FIG. 2) can track fulfillments of objects associated with transactions. Based on the fulfillment actions associated with the objects, the fulfillment-tracking application can determine whether the fulfillment actions satisfy their respective fulfillment conditions. Based on the determination, the fulfillment-tracking application can determine whether to distribute resources requested by one or more service providers. In some instances, the fulfillment-tracking application implements machine-learning techniques to facilitate the determination of whether the fulfillment actions satisfy their respective fulfillment conditions.

### A. Model Selection

The machine-learning techniques for tracking fulfillment conditions can include training a given machine-learning model to facilitate the determination of whether the fulfillment actions satisfy their respective fulfillment conditions (e.g., a training phase 502). The training phase 502 can be initiated by a training subsystem 504 accessing an initial machine-learning model 506 from a models database 508. As an illustrative example, the machine-learning model 506 can be an artificial neural network selected from the models database 508. The neural network can be defined by an example neural network description for machine learning in a neural controller, which can be the same as a processing unit inside a mobile device. Neural network description can include a full specification of the neural network, including the neural architecture. For example, the neural network description can include a description or specification of architecture of the neural network (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

The neural network can reflect the architecture defined in neural network description. In this non-limiting example, the neural network includes an input layer, which includes input data, which can be any type of data such as media content (images, videos, etc.), numbers, text, etc., associated with the corresponding input data described above with reference to FIGS. 1-4. In one illustrative example, the input layer can process data representing a portion of the input media data, such as a patch of data or pixels (e.g., a 128 x 128 patch of data) in an image corresponding to the input media data.

The neural network can include one or more hidden layers. The hidden layers can include n number of hidden layers, where n is an integer greater than or equal to one. The number of hidden layers can include as many layers as needed for a desired processing outcome and/or rendering intent. The neural network further includes an output layer that provides an output resulting from the processing performed by the hidden layers.

The neural network, in this example, is a multi-layer neural network of interconnected nodes. Each node can represent a piece of information. Information associated with the nodes is shared among the different layers and each layer retains information as information is processed. In some cases, the neural network can include a feed-forward neural network, in which case there are no feedback connections where outputs of the neural network are fed back into itself. In other cases, the neural network can include a recurrent neural network, which can have loops that allow information to be carried across nodes while reading in input.

Information can be exchanged between nodes through node-to-node interconnections between the various layers. Nodes of input layer can activate a set of nodes in the first hidden layer. For example, as shown, each input node of input layer is connected to each node of first hidden layer. Nodes of hidden layer can transform the information of each input node by applying activation functions to the information. The information derived from the transformation can then be passed to and can activate the nodes of the next hidden layer, which can perform their own designated functions. Example functions include convolutional, up-sampling, data transformation, pooling, and/or any other suitable functions. The output of hidden layer (e.g.,) can then activate nodes of the next hidden layer, and so on. The output of last hidden layer can activate one or more nodes of output layer, at which point an output is provided. In some cases, while nodes in the neural network are shown as having multiple output lines, a node has a single output and all lines shown as being output from a node represent the same output value.

In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed.

In some instances, the neural network is pre-trained to process the features from the data in the input layer using different hidden layers in order to provide the output through the output layer.

The neural network can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network can represent any other neural or deep learning network, such as an autoencoder, a deep belief nets (DBNs), a recurrent neural networks (RNNs), etc.

Neural Architecture Search (NAS) involves a process in which neural controller searches through various types of neural networks such as CNNs, DBNs, RNNs, etc., to determine which type of neural network, given the input/output description of neural network description, can perform closes to the desired output once trained. This search process is currently cumbersome and resource intensive, because every type of available neural network is treated as a “blackbox.” In other words, a neural controller such as neural controller selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

In addition to the neural network, the machine-learning model can include any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

### B. Training

Once the machine-learning model 506 is selected, the training subsystem 504 can train the machine-learning model 506 using a training dataset accessed from a training database 510. Various training and test data sets may be utilized to train the machine-learning model such that once trained, the machine-learning model 506 can determine whether the fulfillment actions satisfy their respective fulfillment conditions. In some instances, the training dataset can include a plurality of previously-performed fulfillment actions and domain data, in which each of the previously-performed fulfillment actions can be associated with a corresponding label indicating whether the previously-performed fulfillment action satisfies one or more conditions associated with a corresponding domain.

A large pool of data accessed from the training database 510 may be split into two classes of data called training data set and test data set. For example, 70% of the accessed data from the pool may be used as part of the training data set while the remaining 30% of the accessed data from the pool may be used as part of the test data set. The percentages according to which the pool of the data are split into training data set and test data set is not limited to 70/30 and may be set according to a configurable accuracy requirement and/or error tolerance (e.g., the split can be 50/50, 60/40, 70/30, 80/20, 90/10, etc. between the two data sets).

The training subsystem can then use the training dataset to train the machine-learning model 506 by calculating a loss based on a comparison between an output generated from the machine-learning model and a corresponding label of the training data. With each output generated by the machine-learning model 506, the label can thus be used to correct the output of the machine-learning model 506. In some instances, manual feedback is further utilized to adjust the corresponding parameters of the machine-learning model. As noted, weights of different nodes of the machine-learning model 506 may be adjusted/tuned during the training process to improve resulting output.

During training, weights of nodes associated with the machine-learning model 506 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned. In particular, the training of the machine-learning model 506 (e.g., adjustment of the weights) can be performed until a corresponding loss (e.g., a mean square error) reaches a minimum threshold.

Once trained, the training subsystem 504 can test the machine-learning model 506 using the test data set. Examples of testing methods can include regression testing, unit testing, beta testing, and alpha testing. Once the result of testing the machine-learning model 506 is satisfactory (e.g., when outputs of the testing stage is greater than or equal to a threshold or incorrect detections are less than a threshold), the training subsystem 504 can deploy the trained machine-learning model 506 (which may also be referred to as a trained machine learning model or machine trained neural network) to a machine-learning classifier 520, which can use the trained machine-learning model 506 to determine whether the fulfillment actions satisfy their respective fulfillment conditions.

### C. Deployment

After accessing the trained machine-learning model 506, the fulfillment-tracking application can proceed with a deployment phase 512, in which the machine-learning classifier 520 applies the trained machine-learning model 506 to input data to determine whether the fulfillment actions for the subset of objects satisfy their respective fulfillment conditions. The input data for the trained machine-learning model can include one or more fulfillment actions 514 and domain data 516. In some instances, the fulfillment-tracking application can detect in real-time one or more fulfillment actions 514 associated with the set of objects. The one or more fulfillment actions 514 can include any actions performed by the web service to complete and fulfill the transaction for the user of the user device. In some instances, the one or more fulfillment actions correspond to at least one object of the set of objects associated with the transaction. For example, the fulfillment actions 514 can include retrieving a corresponding object from a product warehouse or shipping the corresponding object to a user's address. In some instances, the one or more fulfillment actions 514 include actions performed by the user or another third party that are associated with completion of the transaction. For example, the fulfillment actions 514 can include the user activating the virtual gift card, or a third party acknowledging delivery of the corresponding object to the user's mailing address.

The domain data 516 can be used to identify a domain associated with objects of the one or more fulfillment actions 514. The respective fulfillment conditions can be determined based on the domain data 516, to ensure that the fulfillment actions 514 are relevant to the corresponding domain. For example, the domain data 516 can identify a media-content domain, in which the fulfillment condition can include a user device successfully downloading a video file purchased in the transaction. In another example, the domain data 516 can identify an appliance domain, in which the fulfillment condition can include a purchased appliance being installed in a residence of the user. In some instances, the domain data 516 is used to determine various parameters associated with the fulfillment conditions (e.g., time required for shipment).

An encoding module 518 can then encode the fulfillment actions 514 and the domain data 516 to generate a feature vector. The feature vector can include a set of values (e.g., a numerical array) that represent the input data, in which the feature vector can be used as input to the machine-learning model 506. Example techniques for generating feature vectors can include term frequency-inverse document frequency (TF-IDF) techniques, word-embedding techniques, and tokenization techniques.

The machine-learning classifier 520 can then apply the trained machine-learning model 506 (e.g., the neural network) to the feature vector to generate an output 522 indicating whether the fulfillment conditions have been satisfied. The fulfillment-tracking application can then determine that the fulfillment conditions associated with the subset of objects have been satisfied based on the output. In some instances, the fulfillment-tracking application receives feedback from a resource provider (e.g., the resource provider 204), in which the feedback can include an indication of whether the fulfillment conditions were satisfied based on the one or more fulfillment actions 514. The training subsystem 504 can utilize the feedback to further train the machine-learning model 506 in real-time.

III. MACHINE-LEARNING TECHNIQUES FOR DISTRIBUTING RESOURCES BASED ON FULFILLMENT METRICS

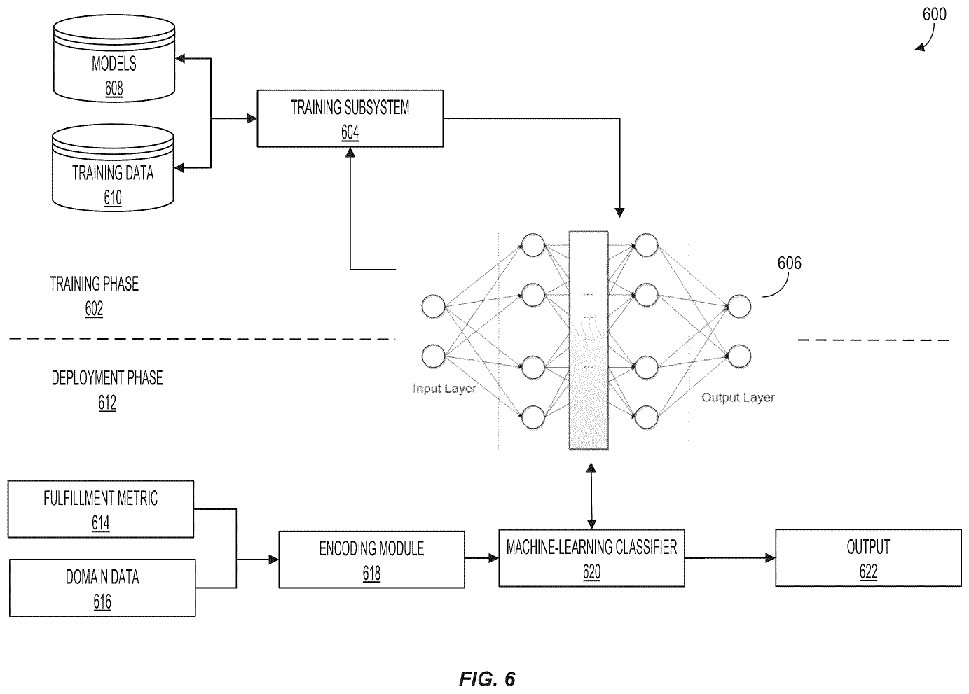

In addition to the above, a machine-learning model can be trained to determine whether the fulfillment metric qualifies for the distribution of the resources. FIG. 6 illustrates an example schematic diagram 600 for distributing resources based on fulfillment metrics, according to some embodiments. As described herein, a fulfillment-tracking application (e.g., the fulfillment-tracking application 202 of FIG. 2) can determine a fulfillment metric based on a subset of objects of a transaction that satisfy their respective fulfillment conditions. The fulfillment-tracking application can then determine whether the requested resources should be distributed based on the fulfillment metric that represents the subset of objects. In some instances, the fulfillment-tracking application implements machine-learning techniques to facilitate the above determination of whether the fulfillment metric can be indicative of the distribution of resources being approved.

A. Model selection

The machine-learning techniques for distributing resources based on fulfillment metrics can include training a given machine-learning model to facilitate the determination of whether a given fulfillment metric qualifies for the distribution of the resources (e.g., a training phase 602). The training phase 602 can be initiated by a training subsystem 604 accessing an initial machine-learning model 606 from a models database 608. As an illustrative example, the machine-learning model 606 can be an artificial neural network selected from the models database 608. The neural network can be defined by an example neural network description for machine learning in a neural controller, which can be the same as a processing unit inside a mobile device. Neural network description can include a full specification of the neural network, including the neural architecture. For example, the neural network description can include a description or specification of architecture of the neural network (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

The neural network can reflect the architecture defined in neural network description. In this non-limiting example, the neural network includes an input layer, which includes input data, which can be any type of data such as media content (images, videos, etc.), numbers, text, etc., associated with the corresponding input data described above with reference to FIGS. 1-4. In one illustrative example, the input layer can process data representing a portion of the input media data, such as a patch of data or pixels (e.g., a 128×128 patch of data) in an image corresponding to the input media data.

The neural network can include one or more hidden layers. The hidden layers can include n number of hidden layers, where n is an integer greater than or equal to one. The number of hidden layers can include as many layers as needed for a desired processing outcome and/or rendering intent. The neural network further includes an output layer that provides an output resulting from the processing performed by the hidden layers.

The neural network, in this example, is a multi-layer neural network of interconnected nodes. Each node can represent a piece of information. Information associated with the nodes is shared among the different layers and each layer retains information as information is processed. In some cases, the neural network can include a feed-forward neural network, in which case there are no feedback connections where outputs of the neural network are fed back into itself. In other cases, the neural network can include a recurrent neural network, which can have loops that allow information to be carried across nodes while reading in input.

Information can be exchanged between nodes through node-to-node interconnections between the various layers. Nodes of input layer can activate a set of nodes in the first hidden layer. For example, as shown, each input node of input layer is connected to each node of first hidden layer. Nodes of hidden layer can transform the information of each input node by applying activation functions to the information. The information derived from the transformation can then be passed to and can activate the nodes of the next hidden layer, which can perform their own designated functions. Example functions include convolutional, up-sampling, data transformation, pooling, and/or any other suitable functions. The output of hidden layer (e.g.,) can then activate nodes of the next hidden layer, and so on. The output of last hidden layer can activate one or more nodes of output layer, at which point an output is provided. In some cases, while nodes in the neural network are shown as having multiple output lines, a node has a single output and all lines shown as being output from a node represent the same output value.

In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed.

In some instances, the neural network is pre-trained to process the features from the data in the input layer using different hidden layers in order to provide the output through the output layer.

The neural network can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network can represent any other neural or deep learning network, such as an autoencoder, a deep belief nets (DBNs), a recurrent neural networks (RNNs), etc.

Neural Architecture Search (NAS) involves a process in which neural controller searches through various types of neural networks such as CNNs, DBNs, RNNs, etc., to determine which type of neural network, given the input/output description of neural network description, can perform closes to the desired output once trained. This search process is currently cumbersome and resource intensive, because every type of available neural network is treated as a “blackbox.” In other words, a neural controller such as neural controller selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

In addition to the neural network, the machine-learning model can include any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

B. Training

Once the machine-learning model 606 is selected the training subsystem 604 can train the machine-learning model 606 using a training dataset accessed from a training database 610. Various training and test data sets may be utilized to train the machine-learning model such that once trained, the machine-learning model 606 can determine whether the fulfillment metric qualifies for the distribution of the resources. In some instances, the training dataset can include fulfillment metrics determined from previous transactions and domain data, in which each of the fulfillment metrics can be associated with a corresponding label indicating whether the resources have been distributed for the corresponding transaction.

A large pool of data accessed from the training database 610 may be split into two classes of data called training data set and test data set. For example, 70% of the accessed data from the pool may be used as part of the training data set while the remaining 30% of the accessed data from the pool may be used as part of the test data set. The percentages according to which the pool of the data are split into training data set and test data set is not limited to 70/30 and may be set according to a configurable accuracy requirement and/or error tolerance (e.g., the split can be 60/50, 60/40, 70/30, 80/20, 90/10, etc. between the two data sets).

The training subsystem can then use the training dataset to train the machine-learning model 606 by calculating a loss based on a comparison between an output generated from the machine-learning model and a corresponding label of the training data. With each output generated by the machine-learning model 606, the label can thus be used to correct the output of the machine-learning model 606. In some instances, manual feedback is further utilized to adjust the corresponding parameters of the machine-learning model. As noted, weights of different nodes of the machine-learning model 606 may be adjusted/tuned during the training process to improve resulting output.

During training, weights of nodes associated with the machine-learning model 606 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned. In particular, the training of the machine-learning model 606 (e.g., adjustment of the weights) can be performed until a corresponding loss (e.g., a mean square error) reaches a minimum threshold.

Once trained, the training subsystem 604 can test the machine-learning model 506 using the test data set. Examples of testing methods can include regression testing, unit testing, beta testing, and alpha testing. Once the result of testing the machine-learning model 606 is satisfactory (e.g., when outputs of the testing stage is greater than or equal to a threshold or incorrect detections are less than a threshold), the training subsystem 604 can deploy the trained machine-learning model 606 (which may also be referred to as a trained machine learning model or machine trained neural network) to a machine-learning classifier 620, which can use the trained machine-learning model 606 to determine whether the fulfillment metric qualifies for the distribution of the resources.

### C. Deployment

After accessing the trained machine-learning model 606, the fulfillment-tracking application can proceed with a deployment phase 612, in which the machine-learning classifier 620 applies the trained machine-learning model 606 to input data to determine whether the fulfillment metric qualifies for the distribution of the resources. The input data for the trained machine-learning model can include the fulfillment metric 614 and domain data 616.

In some instances, the fulfillment-tracking application identifies the fulfillment metric 614 based on the subset of objects that satisfy their respective fulfillment conditions. The fulfillment metric 614 can include any type of value that represent one or more characteristics associated with the subset of objects. For example, the fulfillment metric 614 can be determined to represent a cumulative characteristic of the subset of objects. In some instances, the fulfillment metric 614 includes a statistical value associated with the subject of objects. For example, the fulfillment metric 614 includes a total pecuniary value (e.g., a total dollar amount) corresponding to the subset of objects. In another example, the fulfillment metric 614 can include a count of objects corresponding to the subset of objects (e.g., 4 objects). Other examples of the fulfillment metrics 614 can include an average pecuniary value and a median pecuniary value. In some instances, the fulfillment metric 614 includes any percentage value derived from one or more of the above values. For example, the fulfillment metric 614 can be 0.5 if the count of the subset of objects is 4 while the count of the total number of objects is 8. Additionally or alternatively, the fulfillment metric 614 can include a time-based metric associated with the subject of objects. For example, the fulfillment metric can include a time point at which the fulfillment conditions have been satisfied.

The domain data 616 can be used to identify a domain associated with the set of objects identified in the transactions. The determination of distributing the resources can thus be determined based on the domain data 616, to ensure that the fulfillment metric 614 can be assessed within the context the corresponding domain. Domains can include a media-content domain, an appliance domain, an electronic-device domain, a grocery domain, a fashion domain, a cryptocurrency domain, and other types of domains.

An encoding module 618 can then encode the fulfillment metric 614 and the domain data 616 to generate a feature vector. The feature vector can include a set of values (e.g., a numerical array) that represent the input data, in which the feature vector can be used as input to the machine-learning model 606. Example techniques for generating feature vectors can include term frequency-inverse document frequency (TF-IDF) techniques, word-embedding techniques, and tokenization techniques.

The machine-learning classifier 620 can then apply the trained machine-learning model 606 (e.g., the neural network) to the feature vector to generate an output 622 indicating whether the requested resources should be distributed. In some instances, the machine-learning output can be different based on an amount of the requested resources in various transactions, even if the fulfillment metrics in the same domain reflect the same value.

The fulfillment-tracking application can then determine whether to distribute the requested resources based on the output. In some instances, the fulfillment-tracking application receives feedback from a resource provider (e.g., the resource provider 204), in which the feedback can include an indication of whether the requested resources have indeed been distributed. The training subsystem 604 can utilize the feedback to further train the machine-learning model 606 in real-time.

### IV. EXAMPLE SYSTEMS

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processor 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In an embodiment, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The disclosed techniques for tracking fulfilment of transactions can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, tracking fulfillment statuses of objects associated with transactions described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described herein, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In an embodiment, the information can be delivered using a transfer protocol such as HTML, XML, JavaScript®, CSS, JSON, and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

In an embodiment, the computing device 702 can be connected to one or more additional computing devices and/or services such as merchant computing device 736 and/or a point-of-sale service 734 via the network 722 and using a connection such as the network interface 720. In an embodiment, the point-of-sale service 734 is separate from the merchant computing device 736. In an embodiment, the point-of-sale service 734 is executing on the merchant computing device 736. In an embodiment, the point-of-sale service 734 is executing as one or more services (e.g., the service 730 and/or the service 732) operating within the environment of the computing resources provider. As used herein, a point-of-sale service 734 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 736 to interact with the point-of-sale service 734. In an embodiment, the merchant computing device 736 is a dedicated point-of-service (POS) terminal. In an embodiment, the merchant computing device 736 is a cash register system. In an embodiment, the merchant computing device 736 is an application or web service operating on a computing device such as the computing device 702 described herein. In such an embodiment, the application or web service may be provided by a financial services system (e.g., a bank, a transaction processing system, an inventory management system, or some other such financial services system). In an embodiment, the merchant computing device 736 includes an auxiliary device or system to execute tasks associated with the point-of-sale service 734 (e.g., a payment instrument processing device attached to a smart phone or tablet). In an embodiment, the merchant computing device 736 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 736 is a virtual device (e.g., a virtual kiosk) such as the virtual devices described herein. Although not illustrated here, in an embodiment, the merchant computing device 736 may be one of a plurality of devices that may be interconnected using a network such as the network 722.

In an embodiment, the computing device 702 can be connected to one or more additional computing devices and/or services such as a payment instrument service 738 via the network 722 and using a connection such as the network interface 720. In an embodiment, the payment instrument service 738 connects directly with the point of sale service 734. In an embodiment, elements of the payment instrument service 738 are executing on the merchant computing device 736. In an embodiment, the payment instrument service 738 is executing as one or more services (e.g., the service 730 and/or the service 732) operating within the environment of the computing resources provider. As used herein, a payment instrument service 738 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 738 are running as an application or web service operating on a computing device such as the computing device 702 described herein. In such an embodiment, the application or web service of the payment instrument service 738 may be provided by a financial services system (e.g., a bank, a transaction processing system, an inventory management system, or some other such financial services system). In an embodiment, elements of the payment instrument service 738 are running on an auxiliary device or system configured to execute tasks associated with the payment instrument service 738 (e.g., uses a payment instrument processing device attached to a smart phone or tablet). In an embodiment, elements of the payment instrument service 738 are running on virtual device such as those described herein. Although not illustrated here, in an embodiment, the payment instrument service 738 may be running on one or more of a plurality of devices that may be interconnected using a network such as the network 722.

In an embodiment, the computing device 702 can be connected to one or more additional computing devices and/or services such as an authentication service 740 via the network 722 and using a connection such as the network interface 720. In an embodiment, the authentication service 740 is an element of the payment instrument service 738. In an embodiment, the authentication service 740 is separate from the payment instrument service 738. In an embodiment, the authentication service 740 connects directly with the point of sale service 734. In an embodiment, elements of the authentication service 740 are executing on the merchant computing device 736. In an embodiment, the authentication service 740 is executing as one or more services (e.g., the service 730 and/or the service 732) operating within the environment of the computing resources provider. As used herein, an authentication service 740 is a service used by one or more merchants to authenticate transactions associated with payment instruments. An authentication service may be a third-party service that provides secure and verified authorization of the transactions.

In an embodiment, elements of the authentication service 740 are running as an application or web service operating on a computing device such as the computing device 702 described herein. In such an embodiment, the application or web service of the authentication service 740 may be provided by a financial services system (e.g., a bank, a transaction processing system, an inventory management system, or some other such financial services system). In an embodiment, elements of the authentication service 740 are running on an auxiliary device or system configured to execute tasks associated with the authentication service 740 (e.g., provides authentication using payment instrument processing device attached to a smart phone or tablet). In an embodiment, elements of the authentication service 740 are running on virtual device such as those described herein. Although not illustrated here, in an embodiment, the authentication service 740 may be running on one or more of a plurality of devices that may be interconnected using a network such as the network 722.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 1124 will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method comprising:
receiving a request for distribution of resources, wherein the resources are associated with a transaction to be fulfilled by an entity, and wherein the transaction is associated with a set of objects;
detecting in real-time one or more fulfillment actions associated with the set of objects, wherein the one or more fulfillment actions are detected in real-time as a plurality of fulfillment actions associated with other objects are being received;
determining in real-time that fulfillment conditions associated with a subset of objects have been satisfied, wherein the satisfaction of the fulfillment conditions is determined in real-time as the plurality of fulfillment actions associated with the other objects are being received, and wherein the satisfaction of the fulfillment conditions is determined based on the one or more fulfillment actions;
identifying a fulfillment metric associated with the subset of objects;
determining that the fulfillment metric exceeds a predetermined threshold; and
distributing the resources after determining that the fulfillment metric exceeds the predetermined threshold.

1. The computer-implemented method of claim 1, wherein the fulfillment conditions include a completion of a shipment associated with a corresponding object of the subset of objects.

2. The computer-implemented method of claim 1, wherein the fulfillment metric corresponds to a total pecuniary value corresponding to the subset of objects, a count of objects corresponding to the subset of objects, and/or a time point at which the fulfillment conditions have been satisfied.

3. The computer-implemented method of claim 1, wherein determining the satisfaction of the fulfillment conditions includes:
applying a machine-learning model to the one or more fulfillment actions and domain data associated with the set of objects to generate an output indicating whether the fulfillment conditions have been satisfied; and
determining that the fulfillment conditions associated with the subset of objects have been satisfied based on the output.

4. The computer-implemented method of claim 1, wherein the predetermined threshold includes a statistical value associated with the resources.

5. The computer-implemented method of claim 1, wherein the predetermined threshold is determined based on an elapsed time from a time point at which the request for the distribution of resources was received, and/or domain data associated with the set of objects.

6. The computer-implemented method of claim 1, wherein detecting the one or more fulfillment actions includes analyzing signal data generated by a plurality of sensors.

7. The computer-implemented method of claim 1, further comprising:
determining that the fulfillment metric does not exceed the predetermined threshold;
adjusting an amount of resources to be distributed after determining that the fulfillment metric does not exceed the predetermined threshold; and
distributing the resources using the adjusted amount of resources.

8. The computer-implemented method of claim 1, further comprising:
determining that the fulfillment metric does not exceed the predetermined threshold; and
monitoring for additional fulfillment actions associated with the set of objects after determining that the fulfillment metric does not exceed the predetermined threshold.

9. The computer-implemented method of claim 1, wherein distributing the resources includes generating a notification indicating the distribution of the resources.

10. A system, comprising:
one or more processors; and
memory storing thereon instructions that, as a result of being executed by the one or more processors, cause the system to perform operations comprising:
receiving a request for distribution of resources, wherein the resources are associated with a transaction to be fulfilled by an entity, and wherein the transaction is associated with a set of objects;
detecting in real-time one or more fulfillment actions associated with the set of objects, wherein the one or more fulfillment actions are detected in real-time as a plurality of fulfillment actions associated with other objects are being received;
determining in real-time that fulfillment conditions associated with a subset of objects have been satisfied, wherein the satisfaction of the fulfillment conditions is determined in real-time as the plurality of fulfillment actions associated with the other objects are being received, and wherein the satisfaction of the fulfillment conditions is determined based on the one or more fulfillment actions;
identifying a fulfillment metric associated with the subset of objects;
determining that the fulfillment metric exceeds a predetermined threshold; and
distributing the resources after determining that the fulfillment metric exceeds the predetermined threshold.

11. The system of claim 11, wherein the fulfillment conditions include a completion of a shipment associated with a corresponding object of the subset of objects.

12. The system of claim 11, wherein the fulfillment metric corresponds to a total pecuniary value corresponding to the subset of objects, a count of objects corresponding to the subset of objects, and/or a time point at which the fulfillment conditions have been satisfied.

13. The system of claim 11, wherein determining the satisfaction of the fulfillment conditions includes:
applying a machine-learning model to the one or more fulfillment actions and domain data associated with the set of objects to generate an output indicating whether the fulfillment conditions have been satisfied; and
determining that the fulfillment conditions associated with the subset of objects have been satisfied based on the output.

14. The system of claim 11, wherein the predetermined threshold includes a statistical value associated with the resources.

15. The system of claim 11, wherein the predetermined threshold is determined based on an elapsed time from a time point at which the request for the distribution of resources was received, and/or domain data associated with the set of objects.

16. The system of claim 11, wherein detecting the one or more fulfillment actions includes analyzing signal data generated by a plurality of sensors.

17. The system of claim 11, wherein the instructions further cause the system to perform operations comprising:
determining that the fulfillment metric does not exceed the predetermined threshold;
adjusting an amount of resources to be distributed after determining that the fulfillment metric does not exceed the predetermined threshold; and
distributing the resources using the adjusted amount of resources.

18. The system of claim 11, wherein the instructions further cause the system to perform operations comprising:
determining that the fulfillment metric does not exceed the predetermined threshold; and
monitoring for additional fulfillment actions associated with the set of objects after determining that the fulfillment metric does not exceed the predetermined threshold.

19. The system of claim 11, wherein distributing the resources includes generating a notification indicating the distribution of the resources.

20. A non-transitory, computer-readable storage medium storing thereon executable instructions that, as a result of being executed by one or more processors of a computer system, cause the computer system to perform operations comprising:
receiving a request for distribution of resources, wherein the resources are associated with a transaction to be fulfilled by an entity, and wherein the transaction is associated with a set of objects;
detecting in real-time one or more fulfillment actions associated with the set of objects, wherein the one or more fulfillment actions are detected in real-time as a plurality of fulfillment actions associated with other objects are being received;
determining in real-time that fulfillment conditions associated with a subset of objects have been satisfied, wherein the satisfaction of the fulfillment conditions is determined in real-time as the plurality of fulfillment actions associated with the other objects are being received, and wherein the satisfaction of the fulfillment conditions is determined based on the one or more fulfillment actions;
identifying a fulfillment metric associated with the subset of objects;
determining that the fulfillment metric exceeds a predetermined threshold; and
distributing the resources after determining that the fulfillment metric exceeds the predetermined threshold.

21. The non-transitory, computer-readable storage medium of claim 21, wherein the fulfillment conditions include a completion of a shipment associated with a corresponding object of the subset of objects.

22. The non-transitory, computer-readable storage medium of claim 21, wherein the fulfillment metric corresponds to a total pecuniary value corresponding to the subset of objects, a count of objects corresponding to the subset of objects, and/or a time point at which the fulfillment conditions have been satisfied.

23. The non-transitory, computer-readable storage medium of claim 21, wherein determining the satisfaction of the fulfillment conditions includes:
applying a machine-learning model to the one or more fulfillment actions and domain data associated with the set of objects to generate an output indicating whether the fulfillment conditions have been satisfied; and
determining that the fulfillment conditions associated with the subset of objects have been satisfied based on the output.

24. The non-transitory, computer-readable storage medium of claim 21, wherein the predetermined threshold includes a statistical value associated with the resources.

25. The non-transitory, computer-readable storage medium of claim 21, wherein the predetermined threshold is determined based on an elapsed time from a time point at which the request for the distribution of resources was received, and/or domain data associated with the set of objects.

26. The non-transitory, computer-readable storage medium of claim 21, wherein detecting the one or more fulfillment actions includes analyzing signal data generated by a plurality of sensors.

27. The non-transitory, computer-readable storage medium of claim 21, wherein the instructions further cause the computer system to perform operations comprising:
determining that the fulfillment metric does not exceed the predetermined threshold;
adjusting an amount of resources to be distributed after determining that the fulfillment metric does not exceed the predetermined threshold; and
distributing the resources using the adjusted amount of resources.

28. The non-transitory, computer-readable storage medium of claim 21, wherein the instructions further cause the computer system to perform operations comprising:
determining that the fulfillment metric does not exceed the predetermined threshold; and
monitoring for additional fulfillment actions associated with the set of objects after determining that the fulfillment metric does not exceed the predetermined threshold.

29. The non-transitory, computer-readable storage medium of claim 21, wherein distributing the resources includes generating a notification indicating the distribution of the resources.
